(19) United States
(12) Patent Application Publication
(10) Pub. No.: US 2026/0128857 A1
(43) Pub. Date: May 7, 2026

(54) USER-LEVEL HOMOMORPHIC ENCRYPTION MANAGEMENT METHOD AND APPARATUS

(71) Applicant: HUAWEI TECHNOLOGIES CO., LTD., Shenzhen (CN)

(72) Inventors: Wenhui Wang, Shanghai (CN); Faye Liu, Singapore (SG); Yurong Song, Beijing (CN); Donghui Wang, Beijing (CN)

(73) Assignee: HUAWEI TECHNOLOGIES CO., LTD., Shenzhen (CN)

(21) Appl. No.: 19/434,933

(22) Filed: Dec. 29, 2025

Related U.S. Application Data
(63) Continuation of application No. PCT/CN2023/105087, filed on Jun. 30, 2023.

(51) Int. Cl. H04L 9/00; H04L 9/06

(52) U.S. Cl. CPC H04L 9/008; H04L 9/0618

(57) ABSTRACT

This application provides a user-level homomorphic encryption management method and an apparatus. In the method, a terminal or a network apparatus may determine a homomorphic encryption algorithm by comprehensively considering homomorphic security capabilities of a terminal side and a network side, which helps the terminal provide user-level high privacy protection strength. In addition, a user-level homomorphic key may be determined based on the homomorphic encryption algorithm, thereby implementing user-level key management.

### CROSS-REFERENCE TO RELATED APPLICATIONS

This application is a continuation of International Application No. PCT/CN2023/105087, filed on Jun. 30, 2023, the disclosure of which is hereby incorporated by reference in its entirety.

### TECHNICAL FIELD

This application relates to the field of communication technologies, and in particular, to a user-level homomorphic encryption management method and an apparatus.

### BACKGROUND

Homomorphic encryption (HE) is an encryption scheme in which an operation can be directly performed on a ciphertext. The homomorphic encryption is based on basic encryption, and a function of homomorphic evaluation on a ciphertext is added. Moreover, a computation result obtained by decrypting a ciphertext evaluation result is consistent with a plaintext computation result. For example, in a homomorphic encryption task, one or more homomorphic encryption parties may encrypt data from different sources based on a homomorphic encryption key, and one or more homomorphic evaluation parties may perform homomorphic evaluation based on a homomorphic evaluation key. In a homomorphic encryption task, one or more homomorphic decryption parties may decrypt, based on a homomorphic decryption key, data obtained through homomorphic evaluation, and an obtained decryption result may be provided to one or more data users. The homomorphic decryption party and the data user may be a same entity or different entities. Therefore, how to manage a homomorphic key of a single party or a plurality of parties for a plurality of homomorphic request parties/evaluation parties/decryption parties becomes a problem to be resolved.

### SUMMARY

This application provides a user-level homomorphic encryption management method and an apparatus. According to the method, user-level high privacy protection strength can be provided. In addition, ciphertext data exhibits high reusability, and user-level homomorphic encryption data may be transferred and undergo homomorphic evaluation in different homomorphic encryption tasks.

According to a first aspect, this application provides a user-level homomorphic encryption management method. The method is performed by a terminal. The terminal may be a terminal device or a component (for example, a processor, a chip, or a chip system) of the terminal device, or may be a logic module that can implement all or some functions of a terminal device. The terminal receives a homomorphic security capability of a network side, and determines a homomorphic encryption algorithm based on a homomorphic security capability of the terminal and the homomorphic security capability of the network side. The terminal sends an identifier of the homomorphic encryption algorithm.

In the method, the terminal may receive the homomorphic security capability of the network side, so as to determine the homomorphic encryption algorithm by comprehensively considering homomorphic security capabilities of a terminal side and the network side. This helps the terminal provide user-level high privacy protection strength.

In an embodiment, the homomorphic security capability of the network side is carried in a security mode command, and the homomorphic encryption algorithm is carried in a security mode complete message.

In the method, the homomorphic security capability of the network side and the homomorphic encryption algorithm may be carried in corresponding security signaling, which helps further determine an appropriate homomorphic encryption algorithm to improve privacy protection strength.

According to a second aspect, this application provides a user-level homomorphic encryption management method. The method is performed by a terminal. The terminal may be implemented by a terminal device or a component (for example, a processor, a chip, or a chip system) of the terminal device, or may be implemented by a logic module that can implement all or some functions of a terminal device. The terminal sends a homomorphic security capability of the terminal, and receives an identifier of a homomorphic encryption algorithm, where the homomorphic encryption algorithm is determined by a network side based on the homomorphic security capability of the terminal and a homomorphic security capability of the network side.

In the method, the terminal may send the homomorphic security capability of the terminal to the network side, and the network side determines the homomorphic encryption algorithm by comprehensively considering homomorphic security capabilities of a terminal side and the network side, and feeds back the homomorphic encryption algorithm to the terminal. This helps the terminal provide user-level high privacy protection strength.

In an embodiment, the homomorphic security capability of the terminal is carried in a security mode complete message.

In the method, the homomorphic security capability of the terminal may be carried in corresponding security signaling, which helps the terminal further improve privacy protection strength.

The method according to the first aspect or the second aspect further includes the following possible implementations.

In an embodiment, the terminal determines a homomorphic encryption key and/or a homomorphic decryption key based on the homomorphic encryption algorithm. The homomorphic encryption key is used to encrypt a plaintext message into a first ciphertext, and the homomorphic decryption key is used to decrypt a second ciphertext into a plaintext message.

In the method, because the homomorphic encryption algorithm is determined by comprehensively considering the homomorphic security capabilities of the terminal side and the network side, a user-level homomorphic key determined based on the homomorphic encryption algorithm is unrelated to a homomorphic encryption task, and is related only to a homomorphic enabled node (for example, a homomorphic encryption party/a homomorphic decryption party). This helps improve reusability of the homomorphic key, and helps ciphertext data generated based on the homomorphic key be transferred and undergo homomorphic evaluation in different homomorphic encryption tasks. For example, same ciphertext data may be provided to different network elements, base stations, terminals, APP services, and the like, to perform different types of ciphertext evaluation.

In an embodiment, the terminal receives a homomorphic evaluation key after a homomorphic encryption task is created, where the homomorphic evaluation key is used by one or more homomorphic evaluation parties in the homomorphic encryption task to perform homomorphic evaluation on the first ciphertext, so as to output the second ciphertext.

In an embodiment, a life cycle of the homomorphic evaluation key is duration of the homomorphic encryption task.

In the foregoing method, the homomorphic evaluation key is associated with the homomorphic encryption task. For example, the homomorphic evaluation key is derived after the homomorphic encryption task is created. The homomorphic evaluation key is valid during the homomorphic encryption task. When the homomorphic encryption task is completed, the homomorphic evaluation key becomes invalid.

In an embodiment, the terminal receives first indication information, where the first indication information indicates to destroy a homomorphic key, and the homomorphic key is a homomorphic encryption key, a homomorphic decryption key, or a homomorphic evaluation key. The terminal destroys the homomorphic key.

In the method, the terminal may destroy the homomorphic encryption key, the homomorphic decryption key, or the homomorphic evaluation key based on the first indication information.

In an embodiment, a life cycle of the homomorphic encryption key or the homomorphic decryption key is within time between successful establishment and completion of release of a radio resource control RRC connection of a user, where the user is a homomorphic encryption party or a homomorphic decryption party. The first indication information is carried in RRC release signaling.

In the method, the homomorphic encryption key or the homomorphic decryption key is decoupled from the homomorphic encryption task, and the life cycle of the homomorphic encryption key or the homomorphic decryption key is within a time period between the successful establishment of the RRC connection of the user and destroying of the homomorphic key. In an embodiment, the terminal may receive RRC release signaling, where the RRC release signaling carries the first indication information indicating to destroy the homomorphic key.

In an embodiment, the terminal receives second indication information, where the second indication information indicates to update a homomorphic key, and the homomorphic key is a homomorphic encryption key, a homomorphic decryption key, or a homomorphic evaluation key. The terminal updates the homomorphic key.

In the method, the terminal may update the homomorphic key based on the second indication information.

In an embodiment, the terminal stores the first ciphertext and key information corresponding to the first ciphertext, and/or the second ciphertext and key information corresponding to the second ciphertext. The key information includes one or more of a homomorphic encryption key, a homomorphic decryption key, a homomorphic evaluation key, a key derivation parameter, and a security context.

In the method, the terminal may store ciphertext data and corresponding information such as the homomorphic encryption key, the homomorphic decryption key, the homomorphic evaluation key, the key derivation parameter, and the security context, so that the ciphertext data exhibits high reusability, and user-level homomorphic encryption data may be transferred and undergo homomorphic evaluation in different homomorphic encryption tasks.

In an embodiment, the homomorphic security capability of the network side, the homomorphic security capability of the terminal, the homomorphic encryption algorithm, the first indication information, or the second indication information is carried in signaling with encryption and integrity protection, where the signaling includes radio resource control RRC signaling and/or non-access stratum NAS signaling with integrity protection.

In the method, both the homomorphic security capability of the network side or the terminal and the related first indication information or second indication information may be encrypted and integrity-protected. This facilitates transmission security protection and prevents an attacker from eavesdropping, forging, or tampering with the information.

In an embodiment, the terminal determines a homomorphic encryption key or a homomorphic decryption key based on an upper-level key and homomorphic encryption algorithm information, and encrypts a plaintext message into a first ciphertext by using the homomorphic encryption key, or decrypts a second ciphertext into a plaintext message by using the homomorphic decryption key.

In the method, a user-level key architecture and a management scheme for homomorphic encryption are designed to adapt to a key architecture and management of an existing cellular network. For example, the terminal may derive a homomorphic key based on a USIM symmetric key architecture or a KMC independent key architecture (in the symmetric key architecture or the independent key architecture, a related key is derived based on an upper-level key) and homomorphic encryption algorithm information, thereby implementing a user-level key architecture and management for homomorphic encryption.

In an embodiment, the terminal determines a homomorphic evaluation key based on the homomorphic encryption key or the homomorphic decryption key, where the homomorphic evaluation key is used by the homomorphic evaluation party to perform homomorphic evaluation on the first ciphertext, so as to output the second ciphertext. The terminal sends the homomorphic evaluation key.

In the method, the terminal may derive the homomorphic evaluation key in the USIM symmetric key architecture or the KMC independent key architecture, thereby implementing the user-level key architecture and management for homomorphic encryption.

According to a third aspect, this application provides a user-level homomorphic encryption management method. The method is performed by a first entity. The first entity may be an access network device or a network entity (for example, a core network element or a function network element), or may be a component (for example, a processor, a chip, or a chip system) of an access network device or a network entity, or may be a logic module that can implement all or some of functions an access network device or a network entity. The first entity sends a homomorphic security capability of a network side, and receives an identifier of a homomorphic encryption algorithm, where the homomorphic encryption algorithm is determined by a terminal based on a homomorphic security capability of the terminal and the homomorphic security capability of the network side.

In the method, the first entity may send a homomorphic security capability of the first entity to the terminal, and the terminal determines the homomorphic encryption algorithm by comprehensively considering homomorphic security capabilities of a terminal side and the network side, and feeds back the homomorphic encryption algorithm to the first entity. This helps the network side provide user-level high privacy protection strength.

In an embodiment, the homomorphic security capability of the network side is carried in a security mode command, and the homomorphic encryption algorithm is carried in a security mode complete message.

In the method, the homomorphic security capability of the network side and the homomorphic encryption algorithm may be carried in corresponding security signaling, which helps the first entity provide user-level high privacy protection strength.

According to a fourth aspect, this application provides a user-level homomorphic encryption management method. The method is performed by a first entity. The first entity may be an access network device or a network entity (for example, a core network element or a function network element), or may be a component (for example, a processor, a chip, or a chip system) of an access network device or a network entity, or may be a logic module that can implement all or some functions of an access network device or a network entity. The first entity receives a homomorphic security capability of a terminal, and determines a homomorphic encryption algorithm based on the homomorphic security capability of the terminal and a homomorphic security capability of a network side. The first entity sends an identifier of the homomorphic encryption algorithm.

In the method, the first entity may receive the homomorphic security capability of the terminal, so as to determine the homomorphic encryption algorithm by comprehensively considering homomorphic security capabilities of a terminal side and the network side. This helps the first entity provide user-level high privacy protection strength.

In an embodiment, the homomorphic security capability of the terminal is carried in a security mode complete message.

In the method, the homomorphic security capability of the terminal may be carried in corresponding security signaling, which helps the first entity provide user-level high privacy protection strength.

The method according to the third aspect or the fourth aspect further includes the following possible implementations.

In an embodiment, the first entity determines a homomorphic encryption key and/or a homomorphic decryption key based on the homomorphic encryption algorithm. The homomorphic encryption key is used to encrypt a plaintext message into a first ciphertext, and the homomorphic decryption key is used to decrypt a second ciphertext into a plaintext message.

In the method, because the homomorphic encryption algorithm is determined by comprehensively considering the homomorphic security capabilities of the terminal side and the network side, a user-level homomorphic key determined based on the homomorphic encryption algorithm is unrelated to a homomorphic encryption task, and is related only to a homomorphic enabled node (for example, a homomorphic encryption party/a homomorphic decryption party). This helps improve reusability of the homomorphic key, and helps ciphertext data generated based on the homomorphic key be transferred and undergo homomorphic evaluation in different homomorphic encryption tasks. For example, same ciphertext data may be provided to different network elements, base stations, terminals, APP services, and the like, to perform different types of ciphertext evaluation.

In an embodiment, the first entity determines a homomorphic evaluation key after a homomorphic encryption task is created, where the homomorphic evaluation key is used by one or more homomorphic evaluation parties in the homomorphic encryption task to perform homomorphic evaluation on the first ciphertext, so as to output the second ciphertext. The first entity sends the homomorphic evaluation key.

In an embodiment, a life cycle of the homomorphic evaluation key is duration of the homomorphic encryption task.

In the foregoing method, the homomorphic evaluation key is associated with the homomorphic encryption task. For example, the homomorphic evaluation key is derived after the homomorphic encryption task is created. The homomorphic evaluation key is valid during the homomorphic encryption task. When the homomorphic encryption task is completed, the homomorphic evaluation key becomes invalid.

In an embodiment, the first entity sends first indication information, where the first indication information indicates to destroy a homomorphic key, and the homomorphic key is a homomorphic encryption key, a homomorphic decryption key, or a homomorphic evaluation key. The first entity destroys the homomorphic key.

In an embodiment, a life cycle of the homomorphic encryption key or the homomorphic decryption key is within time between successful establishment and completion of release of a radio resource control RRC connection of a user. The user is a homomorphic encryption party or a homomorphic decryption party. The first indication information is carried in RRC release signaling.

In the foregoing method, a life cycle of a homomorphic key is coupled to the homomorphic encryption task. For example, the life cycle of the homomorphic encryption key is only within a time period of the homomorphic encryption task. After the homomorphic encryption task is completed, the first entity may indicate another homomorphic party to destroy the homomorphic key, which helps reduce key storage overheads. In addition, the first entity also destroys the homomorphic key for the homomorphic encryption task. In an embodiment, the first entity may send RRC release signaling, where the RRC release signaling carries the first indication information that indicates the homomorphic party to destroy the homomorphic key.

In an embodiment, the first entity sends second indication information, where the second indication information indicates to update a homomorphic key. The homomorphic key is a homomorphic encryption key, a homomorphic decryption key, or a homomorphic evaluation key. The first entity updates the homomorphic key.

In the method, the first entity may indicate the terminal to update the homomorphic key, and the first entity also updates the homomorphic key.

In an embodiment, the first entity stores the first ciphertext and key information corresponding to the first ciphertext, and/or the second ciphertext and key information corresponding to the second ciphertext. The key information includes one or more of a user-level homomorphic encryption key, a homomorphic decryption key, a homomorphic evaluation key, a key derivation parameter, and a security context.

In the method, the first entity may store ciphertext data and corresponding information such as the homomorphic encryption key, the homomorphic decryption key, the homomorphic evaluation key, the key derivation parameter, and the security context, so that the ciphertext data exhibits high reusability, and user-level homomorphic encryption data may be transferred and undergo homomorphic evaluation in different homomorphic encryption tasks.

In an embodiment, the homomorphic security capability of the network side, the homomorphic security capability of the terminal, the homomorphic encryption algorithm, the first indication information, or the second indication information is carried in signaling with encryption and integrity protection. The signaling includes radio resource control RRC signaling and/or non-access stratum NAS signaling with integrity protection.

In the method, both the homomorphic security capability of the network side or the terminal and the related first indication information or second indication information may be encrypted and integrity-protected. This facilitates transmission security protection and prevents an attacker from eavesdropping, forging, or tampering with the information.

In an embodiment, the first entity determines a homomorphic encryption key or a homomorphic decryption key based on an upper-level key and homomorphic encryption algorithm information, and encrypts a plaintext message into a first ciphertext by using the homomorphic encryption key, or decrypts a second ciphertext into a plaintext message by using the homomorphic decryption key.

In the method, a user-level key architecture and a management scheme for homomorphic encryption are designed to adapt to a key architecture and management of an existing cellular network. For example, the first entity may derive a homomorphic key based on a USIM symmetric key architecture or a KMC independent key architecture (in the symmetric key architecture or the independent key architecture, a related key is derived based on an upper-level key) and homomorphic encryption algorithm information, thereby implementing a user-level key architecture and management for homomorphic encryption.

In an embodiment, the first entity determines a homomorphic evaluation key based on the homomorphic encryption key or the homomorphic decryption key, where the homomorphic evaluation key is used by the homomorphic evaluation party to perform homomorphic evaluation on the first ciphertext, so as to output the second ciphertext. The terminal sends the homomorphic evaluation key.

In the method, the first entity may derive the homomorphic evaluation key in the USIM symmetric key architecture or the KMC independent key architecture, thereby implementing the user-level key architecture and management for homomorphic encryption.

According to a fifth aspect, this application provides a user-level homomorphic encryption management method. The method is performed by a first entity. The first entity may be an access network device or a network entity (for example, a core network element or a function network element), or may be a component (for example, a processor, a chip, or a chip system) of an access network device or a network entity, or may be a logic module that can implement all or some functions of an access network device or a network entity. The first entity determines a homomorphic encryption key or a homomorphic decryption key based on an upper-level key and homomorphic encryption algorithm information. The first entity encrypts a plaintext message into a first ciphertext by using the homomorphic encryption key, or decrypts a second ciphertext into a plaintext message by using the homomorphic decryption key.

In the method, a user-level key architecture and a management scheme for homomorphic encryption are designed to adapt to a key architecture and management of an existing cellular network. For example, the first entity may derive a homomorphic key based on a USIM symmetric key architecture or a KMC independent key architecture (in the symmetric key architecture or the independent key architecture, a related key is derived based on an upper-level key) and homomorphic encryption algorithm information, thereby implementing a user-level key architecture and management for homomorphic encryption.

In an embodiment, the first entity determines a homomorphic evaluation key based on the homomorphic encryption key or the homomorphic decryption key, where the homomorphic evaluation key is used by a homomorphic evaluation party to perform homomorphic evaluation on the first ciphertext, so as to output the second ciphertext. The first entity sends the homomorphic evaluation key.

In the method, the first entity may derive the homomorphic evaluation key in the USIM symmetric key architecture or the KMC independent key architecture, thereby implementing the user-level key architecture and management for homomorphic encryption.

In an embodiment, the upper-level key is a first key, and the first key is an anchor key derived by a first network element (for example, a network element or an entity having an authentication function). The first entity determines a homomorphic encryption key or a homomorphic decryption key of a network function NF network element based on the first key and a first homomorphic algorithm input parameter. The first homomorphic algorithm input parameter includes one or more of an algorithm type distinguisher, an algorithm identifier, a network function type, a user identity, a non-access stratum NAS count, and an ABBA parameter.

In the method, the first entity may generate the homomorphic encryption key or the homomorphic decryption key of the corresponding function network element based on the anchor key in the symmetric key architecture and the first homomorphic algorithm input parameter. That is, the first entity may reuse an existing symmetric key architecture to generate a homomorphic encryption key or a homomorphic decryption key, and an implementation process is simpler and faster. The homomorphic encryption key or the homomorphic decryption key generated in the method may be used to perform homomorphic encryption or homomorphic decryption on core network data related to a user.

In an embodiment, the upper-level key is a second key, and the second key is a key derived from an anchor key by a second network element, where the second network element is a network element or an entity having an access and mobility management function. The first entity determines a homomorphic encryption key or a homomorphic decryption key of the second network element based on the second key and a second homomorphic algorithm input parameter. The second homomorphic algorithm input parameter includes one or more of an algorithm type distinguisher, an algorithm identifier, and a non-access stratum NAS count.

In the method, the first entity may generate a homomorphic encryption key or a homomorphic decryption key of a corresponding function network element based on the second key derived from the anchor key in the symmetric key architecture and the second homomorphic algorithm input parameter. That is, the first entity may reuse an existing symmetric key architecture to generate a homomorphic encryption key or a homomorphic decryption key, and an implementation process is simpler and faster. The homomorphic encryption key or the homomorphic decryption key generated in the method may be used to perform homomorphic encryption or homomorphic decryption on core network data related to a user.

In an embodiment, the upper-level key is a third key, and the third key is a key derived again from the second key by the second network element. The first entity determines a homomorphic encryption key or a homomorphic decryption key of an access network device based on the third key and a third homomorphic algorithm input parameter. The third homomorphic algorithm input parameter includes an algorithm type distinguisher and/or an algorithm identifier.

In the method, the first entity may generate the homomorphic encryption key or the homomorphic decryption key of the access network device based on the third key derived from the second key in the symmetric key architecture and the third homomorphic algorithm input parameter. That is, the first entity may reuse an existing symmetric key architecture to generate a homomorphic encryption key or a homomorphic decryption key, and an implementation process is simpler and faster. The homomorphic encryption key or the homomorphic decryption key generated in the method is mainly used to perform homomorphic encryption or homomorphic decryption on access network data related to a user.

In an embodiment, the upper-level key is a working key in an independent key architecture. The first entity determines a homomorphic encryption key or a homomorphic decryption key of a core network element based on the working key in the independent key architecture and a fourth homomorphic algorithm input parameter. The fourth homomorphic algorithm input parameter includes one or more of a random number RAND, a service network name, a network function type, an algorithm type distinguisher, an algorithm identifier, a user identity, and an ABBA parameter.

In the method, the first entity may generate the homomorphic encryption key or the homomorphic decryption key of the corresponding core network element based on the working key in the independent key architecture and the fourth homomorphic algorithm input parameter. That is, the first entity may design a new independent key architecture, which helps centrally manage the homomorphic encryption key or the homomorphic decryption key of the core network element by using a management device. The homomorphic encryption key or the homomorphic decryption key generated in the method may be used to perform homomorphic encryption or homomorphic decryption on core network data.

In an embodiment, the upper-level key is a working key in an independent key architecture. The first entity determines a homomorphic encryption key and a homomorphic decryption key of an access network device based on the working key in the independent key architecture and a fifth homomorphic algorithm input parameter. The fifth homomorphic algorithm input parameter includes one or more of a random number RAND, a service network name, a network function type, an algorithm type distinguisher, an algorithm identifier, a user identity, an ABBA parameter, a non-access stratum NAS count, and an access type.

In the method, the first entity may generate the homomorphic encryption key or the homomorphic decryption key of the access network device based on the working key in the independent key architecture and the fifth homomorphic algorithm input parameter. That is, the first entity may design a new independent key architecture, which helps centrally manage the homomorphic encryption key or the homomorphic decryption key of the access network device by using a management device. The homomorphic encryption key or the homomorphic decryption key generated in the method may be used to perform homomorphic encryption or homomorphic decryption on access network data.

According to a sixth aspect, this application provides a communication apparatus. The communication apparatus may be a terminal or an apparatus of a terminal. In an embodiment, the communication apparatus may include a functional module. The functional module may be implemented by a hardware circuit, software, or a combination of a hardware circuit and software. The functional module is configured to implement the method according to the first aspect and the possible implementations of the first aspect.

In an embodiment, the communication apparatus includes a communication unit and a processing unit. The communication unit is configured to receive a homomorphic security capability of a network side. The processing unit is configured to determine a homomorphic encryption algorithm based on a homomorphic security capability of a terminal and the homomorphic security capability of the network side. The communication unit is further configured to send an identifier of a homomorphic encryption algorithm.

In an embodiment, the homomorphic security capability of the network side is carried in a security mode command, and the homomorphic encryption algorithm is carried in a security mode complete message.

According to a seventh aspect, this application provides a communication apparatus. The communication apparatus may be a terminal or an apparatus of a terminal. In an embodiment, the communication apparatus may include a functional module. The functional module may be implemented by a hardware circuit, software, or a combination of a hardware circuit and software. The functional module is configured to implement the method according to the second aspect and the possible implementations of the second aspect.

In an embodiment, the communication apparatus includes a communication unit and a processing unit. The communication unit is configured to send a homomorphic security capability of a terminal. The communication unit is further configured to receive an identifier of a homomorphic encryption algorithm, where the homomorphic encryption algorithm is determined by a network side based on the homomorphic security capability of the terminal and a homomorphic security capability of the network side.

In an embodiment, the homomorphic security capability of the terminal is carried in a security mode complete message.

The apparatus according to the sixth aspect or the seventh aspect further includes the following possible implementations.

In an embodiment, the processing unit is configured to determine a homomorphic encryption key and/or a homomorphic decryption key based on the homomorphic encryption algorithm. The homomorphic encryption key is used to encrypt a plaintext message into a first ciphertext, and the homomorphic decryption key is used to decrypt a second ciphertext into a plaintext message.

In an embodiment, the communication unit is configured to receive a homomorphic evaluation key after a homomorphic encryption task is created, where the homomorphic evaluation key is used by one or more homomorphic evaluation parties in the homomorphic encryption task to perform homomorphic evaluation on the first ciphertext, so as to output the second ciphertext.

In an embodiment, a life cycle of the homomorphic evaluation key is duration of the homomorphic encryption task.

In an embodiment, the communication unit is configured to receive first indication information, where the first indication information indicates to destroy a homomorphic key. The homomorphic key is a homomorphic encryption key, a homomorphic decryption key, or a homomorphic evaluation key. The processing unit is configured to destroy the homomorphic key.

In an embodiment, a life cycle of the homomorphic encryption key or the homomorphic decryption key is within time between successful establishment and completion of release of a radio resource control RRC connection of a user, where the user is a homomorphic encryption party or a homomorphic decryption party. The first indication information is carried in RRC release signaling.

In an embodiment, the communication unit is configured to receive second indication information, where the second indication information indicates to update a homomorphic key. The homomorphic key is a homomorphic encryption key, a homomorphic decryption key, or a homomorphic evaluation key. The processing unit is configured to update the homomorphic key.

In an embodiment, the processing unit is configured to store the first ciphertext and key information corresponding to the first ciphertext, and/or the second ciphertext and key information corresponding to the second ciphertext. The key information includes one or more of a homomorphic encryption key, a homomorphic decryption key, a homomorphic evaluation key, a key derivation parameter, and a security context.

In an embodiment, the homomorphic security capability of the network side, the homomorphic security capability of the terminal, the homomorphic encryption algorithm, the first indication information, or the second indication information is carried in signaling with encryption and integrity protection, where the signaling includes radio resource control RRC signaling and/or non-access stratum NAS signaling with integrity protection.

In an embodiment, the processing unit is configured to determine a homomorphic encryption key or a homomorphic decryption key based on an upper-level key and homomorphic encryption algorithm information, and encrypt a plaintext message into a first ciphertext by using the homomorphic encryption key, or decrypt a second ciphertext into a plaintext message by using the homomorphic decryption key.

In an embodiment, the processing unit is configured to determine a homomorphic evaluation key based on the homomorphic encryption key or the homomorphic decryption key. The homomorphic evaluation key is used by the homomorphic evaluation party to perform homomorphic evaluation on the first ciphertext, so as to output the second ciphertext. The communication unit is configured to send the homomorphic evaluation key.

According to an eighth aspect, this application provides a communication apparatus. The communication apparatus may be an access network device or a network entity, or may be an apparatus of an access network device or a network entity. In an embodiment, the communication apparatus may include a functional module. The functional module may be implemented by a hardware circuit, software, or a combination of a hardware circuit and software. The functional module is configured to implement the method according to the third aspect and the possible implementations of the third aspect.

In an embodiment, the communication apparatus includes a communication unit and a processing unit. The communication unit is configured to send a homomorphic security capability of a network side. The communication unit is further configured to receive an identifier of a homomorphic encryption algorithm, where the homomorphic encryption algorithm is determined by a terminal based on a homomorphic security capability of the terminal and the homomorphic security capability of the network side.

In an embodiment, the homomorphic security capability of the network side is carried in a security mode command, and the homomorphic encryption algorithm is carried in a security mode complete message.

According to a ninth aspect, this application provides a communication apparatus. The communication apparatus may be an access network device or a network entity, or may be an apparatus of an access network device or a network entity. In an embodiment, the communication apparatus may include a functional module. The functional module may be implemented by a hardware circuit, software, or a combination of a hardware circuit and software. The functional module is configured to implement the method according to the fourth aspect and the possible implementations of the fourth aspect.

In an embodiment, the communication apparatus includes a communication unit and a processing unit. The communication unit is configured to receive a homomorphic security capability of a terminal. The processing unit is configured to determine a homomorphic encryption algorithm based on the homomorphic security capability of the terminal and a homomorphic security capability of a network side. The communication unit is further configured to send an identifier of a homomorphic encryption algorithm.

In an embodiment, the homomorphic security capability of the terminal is carried in a security mode complete message.

The apparatus according to the eighth aspect or the ninth aspect further includes the following possible implementations.

In an embodiment, the processing unit is configured to determine a homomorphic encryption key and/or a homomorphic decryption key based on the homomorphic encryption algorithm. The homomorphic encryption key is used to encrypt a plaintext message into a first ciphertext, and the homomorphic decryption key is used to decrypt a second ciphertext into a plaintext message.

In an embodiment, the processing unit is configured to determine a homomorphic evaluation key after a homomorphic encryption task is created, where the homomorphic evaluation key is used by one or more homomorphic evaluation parties in the homomorphic encryption task to perform homomorphic evaluation on the first ciphertext, so as to output the second ciphertext. The communication unit is configured to send the homomorphic evaluation key.

In an embodiment, a life cycle of the homomorphic evaluation key is duration of the homomorphic encryption task.

In an embodiment, the communication unit is configured to send first indication information, where the first indication information indicates to destroy a homomorphic key, and the homomorphic key is a homomorphic encryption key, a homomorphic decryption key, or a homomorphic evaluation key. The processing unit is configured to destroy the homomorphic key.

In an embodiment, a life cycle of the homomorphic encryption key or the homomorphic decryption key is within time between successful establishment and completion of release of a radio resource control RRC connection of a user. The user is a homomorphic encryption party or a homomorphic decryption party. The first indication information is carried in RRC release signaling.

In an embodiment, the communication unit is configured to send second indication information, where the second indication information indicates to update a homomorphic key. The homomorphic key is a homomorphic encryption key, a homomorphic decryption key, or a homomorphic evaluation key. A first entity updates the homomorphic key.

In an embodiment, the processing unit is configured to store the first ciphertext and key information corresponding to the first ciphertext, and/or the second ciphertext and key information corresponding to the second ciphertext. The key information includes one or more of a user-level homomorphic encryption key, a homomorphic decryption key, a homomorphic evaluation key, a key derivation parameter, and a security context.

In an embodiment, the homomorphic security capability of the network side, the homomorphic security capability of the terminal, the homomorphic encryption algorithm, the first indication information, or the second indication information is carried in signaling with encryption and integrity protection. The signaling includes radio resource control RRC signaling and/or non-access stratum NAS signaling with integrity protection.

In an embodiment, the processing unit is configured to determine a homomorphic encryption key or a homomorphic decryption key based on an upper-level key and homomorphic encryption algorithm information, and encrypt a plaintext message into a first ciphertext by using the homomorphic encryption key, or decrypt a second ciphertext into a plaintext message by using the homomorphic decryption key.

In an embodiment, the processing unit is configured to determine a homomorphic evaluation key based on the homomorphic encryption key or the homomorphic decryption key, where the homomorphic evaluation key is used by the homomorphic evaluation party to perform homomorphic evaluation on the first ciphertext, so as to output the second ciphertext. The communication unit is configured to send the homomorphic evaluation key.

According to a tenth aspect, this application provides a communication apparatus. The communication apparatus may be an access network device or a network entity, or may be an apparatus of an access network device or a network entity. In an embodiment, the communication apparatus may include a functional module. The functional module may be implemented by a hardware circuit, software, or a combination of a hardware circuit and software. The functional module is configured to implement the method according to the fifth aspect and the possible implementations of the fifth aspect.

In an embodiment, the communication apparatus includes a communication unit and a processing unit. The processing unit is configured to determine a homomorphic encryption key or a homomorphic decryption key based on an upper-level key and homomorphic encryption algorithm information. The processing unit is further configured to encrypt a plaintext message into a first ciphertext by using the homomorphic encryption key, or decrypt a second ciphertext into a plaintext message by using the homomorphic decryption key.

In an embodiment, the processing unit is configured to determine a homomorphic evaluation key based on the homomorphic encryption key or the homomorphic decryption key, where the homomorphic evaluation key is used by a homomorphic evaluation party to perform homomorphic evaluation on the first ciphertext, so as to output the second ciphertext. A first entity sends the homomorphic evaluation key.

In an embodiment, the upper-level key is a first key, and the first key is an anchor key derived by a first network element (for example, a network element or an entity having an authentication function). The processing unit is configured to determine a homomorphic encryption key or a homomorphic decryption key of a network function NF network element based on the first key and a first homomorphic algorithm input parameter. The first homomorphic algorithm input parameter includes one or more of an algorithm type distinguisher, an algorithm identifier, a network function type, a user identity, a non-access stratum NAS count, and an ABBA parameter.

In an embodiment, the upper-level key is a second key, and the second key is a key derived from an anchor key by a second network element, where the second network element is a network element or an entity having an access and mobility management function. The processing unit is configured to determine a homomorphic encryption key or a homomorphic decryption key of the second network element (for example, a network element having an access and mobility management function) based on the second key and a second homomorphic algorithm input parameter. The second homomorphic algorithm input parameter includes one or more of an algorithm type distinguisher, an algorithm identifier, and a non-access stratum NAS count.

In an embodiment, the upper-level key is a third key, and the third key is a key derived again from the second key by the second network element. The processing unit is configured to determine a homomorphic encryption key or a homomorphic decryption key of an access network device based on the third key and a third homomorphic algorithm input parameter. The third homomorphic algorithm input parameter includes an algorithm type distinguisher and/or an algorithm identifier.

In an embodiment, the upper-level key is a working key in an independent key architecture. The processing unit is configured to determine a homomorphic encryption key or a homomorphic decryption key of a core network element based on the working key in the independent key architecture and a fourth homomorphic algorithm input parameter. The fourth homomorphic algorithm input parameter includes one or more of a random number RAND, a service network name, a network function type, an algorithm type distinguisher, an algorithm identifier, a user identity, and an ABBA parameter.

In an embodiment, the upper-level key is a working key in an independent key architecture. The processing unit is configured to determine a homomorphic encryption key and a homomorphic decryption key of an access network device based on the working key in the independent key architecture and a fifth homomorphic algorithm input parameter. The fifth homomorphic algorithm input parameter includes one or more of a random number RAND, a service network name, a network function type, an algorithm type distinguisher, an algorithm identifier, a user identity, an ABBA parameter, a non-access stratum NAS count, and an access type.

For the sixth aspect to the tenth aspect, in an example, the processing unit may be a processor, and the communication unit may be a transceiver unit, a transceiver, or a communication interface. It may be understood that when the communication apparatus is a communication device (for example, a terminal or a network device), the communication unit may be a transceiver in the communication apparatus, for example, implemented by using an antenna, a feeder, a codec, or the like in the communication apparatus. Alternatively, if the communication apparatus is a chip disposed in a device, the processing unit may be a processing circuit, a logic circuit, or the like of the chip, and the communication unit may be an input/output interface of the chip, for example, an input/output circuit or a pin.

According to an eleventh aspect, this application provides a communication apparatus, including a processor, configured to enable, by executing instructions or by using a logic circuit, the communication apparatus to implement the method according to any one of the first aspect, the second aspect, and the possible implementations of the first aspect and the second aspect.

In an embodiment, the communication apparatus further includes a memory, and the memory is configured to store the instructions. In an embodiment, the memory is integrated with the processor.

In an embodiment, the communication apparatus further includes a communication interface, configured to input and/or output a signal.

According to a twelfth aspect, this application provides another communication apparatus, including a processor, configured to enable, by executing instructions or by using a logic circuit, the communication apparatus to implement the method according to any one of the third aspect, the fourth aspect, and the possible implementations of the third aspect and the fourth aspect.

In an embodiment, the communication apparatus further includes a memory, and the memory is configured to store the instructions. In an embodiment, the memory is integrated with the processor.

In an embodiment, the communication apparatus further includes a communication interface, configured to input and/or output a signal.

According to a thirteenth aspect, this application provides another communication apparatus, including a processor, configured to enable, by executing instructions or by using a logic circuit, the communication apparatus to implement the method according to any one of the fifth aspect and the possible implementations of the fifth aspect.

In an embodiment, the communication apparatus further includes a memory, and the memory is configured to store the instructions. In an embodiment, the memory is integrated with the processor.

In an embodiment, the communication apparatus further includes a communication interface, configured to input and/or output a signal.

According to a fourteenth aspect, this application provides a communication system. The communication system includes a plurality of apparatuses or devices according to the sixth aspect to the thirteenth aspect, and the apparatuses or devices are enabled to perform the method according to any one of the first aspect to the fifth aspect and the possible implementations of the first aspect to the fifth aspect.

According to a fifteenth aspect, this application provides a computer-readable storage medium. The computer-readable storage medium stores instructions. When the instructions are run on a computer, the computer is enabled to perform the method according to any one of the first aspect to the fifth aspect and the possible implementations of the first aspect to the fifth aspect.

According to a sixteenth aspect, this application provides a chip system. The chip system includes a processor and an interface. In an embodiment, the chip system may further include a memory. The chip system is configured to implement the method according to any one of the first aspect to the fifth aspect and the possible implementations of the first aspect to the fifth aspect. The chip system may include a chip, or may include a chip and another discrete component.

According to a seventeenth aspect, this application provides a computer program product, including instructions. When the instructions are run on a computer, the computer is enabled to perform the method according to any one of the first aspect to the fifth aspect and the possible implementations of the first aspect to the fifth aspect.

### BRIEF DESCRIPTION OF DRAWINGS

FIG. 1 is a diagram of a communication system according to this application;

FIG. 2 is a diagram of a key architecture generated based on a key hierarchy in a 5G system;

FIG. 3a to FIG. 3e are diagrams of a homomorphic encryption scheme;

FIG. 4 is a diagram of a network scenario in which there are a plurality of parties in a homomorphic encryption task;

FIG. 5 is a diagram of a wireless network protocol layer;

FIG. 6a and FIG. 6b are schematic flowcharts of a user-level homomorphic encryption management method according to this application;

FIG. 7 is a diagram of a network scenario in which there are a plurality of parties in a homomorphic encryption task according to this application;

FIG. 8a is a schematic flowchart of determining a homomorphic encryption algorithm by a terminal in a security mode complete procedure according to this application;

FIG. 8b is a schematic flowchart of determining a homomorphic encryption algorithm by a terminal after a security mode complete procedure according to this application;

FIG. 9a is a schematic flowchart of determining a homomorphic encryption algorithm by a network apparatus in a security mode complete procedure according to this application;

FIG. 9b is a schematic flowchart of determining a homomorphic encryption algorithm by a network apparatus after a security mode complete procedure according to this application;

FIG. 10 is a schematic flowchart of key derivation for a homomorphic evaluation key according to this application;

FIG. 11 is a schematic flowchart of destroying a homomorphic key according to this application;

FIG. 12 is a schematic flowchart of updating a homomorphic key according to this application;

FIG. 13 is a schematic flowchart of another user-level homomorphic encryption management method according to this application;

FIG. 14a is a diagram of deriving a homomorphic key based on a USIM symmetric key architecture according to this application;

FIG. 14b is a diagram of deriving a homomorphic key based on a KMC independent key architecture according to this application;

FIG. 15 is a diagram of an interactive homomorphic key generation procedure according to this application;

FIG. 16 is a diagram of a communication apparatus according to this application; and

FIG. 17 is a diagram of another communication apparatus according to this application.

### DESCRIPTION OF EMBODIMENTS

In embodiments of this application, “/” may represent an “or” relationship between associated objects. For example, A/B may represent A or B. “And/or” may be used to indicate that there are three relationships between associated objects. For example, A and/or B may represent the following three cases: Only A exists, both A and B exist, and only B exists, where A and B may be singular or plural. To facilitate description of technical solutions in embodiments of this application, in embodiments of this application, terms such as “first” and “second” may be used to distinguish between technical features with same or similar functions. The terms such as “first” and “second” do not limit a quantity and an execution sequence, and the terms such as “first” and “second” do not indicate a definite difference. In embodiments of this application, a term such as “example” or “for example” is used to represent an example, an illustration, or a description. Any embodiment or design scheme described with “example” or “for example” should not be explained as being more preferred or having more advantages than another embodiment or design scheme. Use of the term such as “example” or “for example” is intended to present a related concept in a manner for ease of understanding.

The following describes the technical solutions in embodiments of this application with reference to accompanying drawings in embodiments of this application.

To resolve a problem of how to manage a homomorphic key of a single party or a plurality of parties for a plurality of homomorphic request parties/evaluation parties/decryption parties, this application provides a user-level homomorphic encryption management method and an apparatus. According to the method, keys of a plurality of homomorphic encryption parties/evaluation parties/decryption parties may be managed, to provide user-level high privacy protection strength and high reusability of a ciphertext.

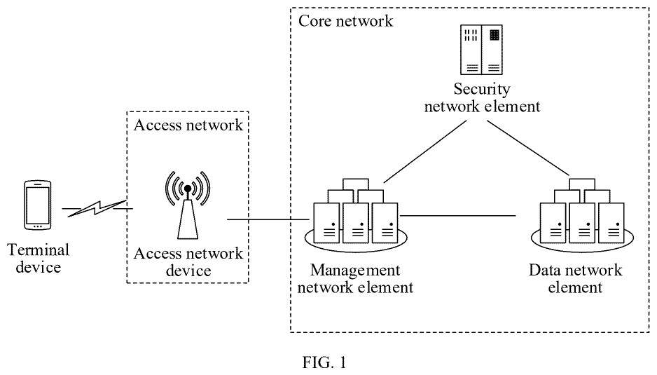

The user-level homomorphic encryption management method provided in this application may be applied to a communication system shown in FIG. 1. For example, the communication system includes a terminal device, an access network, and a core network. The access network includes an access network device, and the core network includes a core network function entity (also referred to as a core network element). In an embodiment, the user-level homomorphic encryption management method provided in this application may be applied to any communication system (for example, a cellular network, an internet of things, or a dedicated network), to provide an encryption service for the communication system, and improve security of the communication system. For example, the access network and the core network in FIG. 1 may be dedicated networks.

The communication system in this application may include but is not limited to communication systems using various radio access technologies (RAT). For example, the communication system may be a narrowband internet of things (NB-IoT) system, an LTE communication system, a 5G (or referred to as new radio (NR)) communication system, or a transition system between the LTE communication system and the 5G communication system, where the transition system may also be referred to as a 4.5G communication system. Certainly, the communication system may be an evolved communication system after 5G, for example, a 6th generation (6G) system or even a 7th generation (7G) system. A network architecture and a service scenario described in embodiments of this application are intended to describe the technical solutions in embodiments of this application more clearly, and do not constitute a limitation on the technical solutions provided in embodiments of this application. One of ordinary skilled in the art may know that with evolution of communication network architectures and emergence of new service scenarios, the technical solutions provided in embodiments of this application are also applicable to similar technical problems.

The terminal device is also referred to as a terminal, user equipment (UE), a mobile station (MS), a mobile terminal (MT), mobile equipment (ME), or the like, and is a device that provides voice and/or data connectivity for a user. For example, the terminal device includes a handheld device, a vehicle-mounted device, or the like that has a wireless connection function. Currently, the terminal device may be a mobile phone, a tablet computer, a notebook computer, a palmtop computer, a mobile internet device (MID), a wearable device (for example, a smartwatch, a smart band, or a pedometer), a vehicle-mounted device (for example, a vehicle, a bicycle, an electric vehicle, an airplane, a ship, a train, or a high-speed train), a satellite terminal, a virtual reality (VR) device, an augmented reality (AR) device, a smart point of sale (POS) machine, customer-premises equipment (CPE), a wireless terminal in industrial control, a smart home device (for example, a refrigerator, a television, an air conditioner, or an electricity meter), a smart robot, a robot arm, a workshop device, a wireless terminal in self-driving, a wireless terminal in telemedicine, a wireless terminal in a smart grid, a wireless terminal in transportation safety, a wireless terminal in a smart city, a wireless terminal in a smart home, a flight device (for example, a smart robot, a hot air balloon, an uncrewed aerial vehicle, or an airplane), or the like. The terminal device may alternatively be another device having functions of a terminal. For example, the terminal device may alternatively be a device that functions as a terminal in D2D communication.

A device form of the terminal is not limited in embodiments of this application. An apparatus configured to implement a function of the terminal device may be a terminal device, or may be an apparatus that can support the terminal device in implementing the function, for example, a chip system. The apparatus may be installed in the terminal device or used in a manner of matching the terminal device. In embodiments of this application, the chip system may include a chip, or may include a chip and another discrete component.

The access network device, also referred to as a base station, is a radio access network (RAN) node (or device) that connects the terminal device to a wireless network. For example, examples of some RAN nodes are: a continuously evolved NodeB (gNB), a transmission and reception point (TRP), an evolved NodeB (eNB), a radio network controller (RNC), a NodeB (NB), a base station controller (BSC), a base transceiver station (BTS), a home base station (for example, a home evolved NodeB, or a home NodeB, HNB), a baseband unit (BBU), a wireless fidelity (Wi-Fi) access point (AP), a satellite in a satellite communication system, a radio controller in a cloud radio access network (CRAN) scenario, a wearable device, an uncrewed aerial vehicle, a device in an internet of vehicles (for example, a vehicle-to-everything (V2X) device), a communication device in device-to-device (D2D) communication, or the like. In addition, in a network structure, a network device may include a central unit (CU) node, a distributed unit (DU) node, or a RAN device including a CU node and a DU node. The RAN device including the CU node and the DU node splits protocol layers of an eNB in a long term evolution (LTE) system. Functions of some protocol layers are centrally controlled by a CU, functions of some or all of remaining protocol layers are distributed in a DU, and the CU centrally controls the DU. In some deployment of the network device, the CU may be further split into a CU-control plane (CP), a CU-user plane (UP), and the like. In some other deployment of the network device, the network device may alternatively be an antenna unit (RU), or the like. In still some other deployment of the network device, the network device may alternatively be of an open radio access network (ORAN) architecture or the like. A type of the network device is not limited in this application. For example, when the network device is of the ORAN architecture, the network device in embodiments of this application may be an access network device in an ORAN, a module in the access network device, or the like. In an ORAN system, a CU may also be referred to as an open (O)-CU, a DU may also be referred to as an O-DU, a CU-DU may also be referred to as an O-CU-DU, a CU-UP may also be referred to as an O-CU-UP, and an RU may also be referred to as an O-RU.

The core network element in this application may be classified into three types in terms of functions: a security network element, a data network element, and a management network element.

For example, the security network element described in this application may include but is not limited to a unified data management (UDM) network element, an authentication credential repository and processing function (ARPF) network element, an authentication server function (AUSF) network element, a security anchor function (SEAF), an access and mobility management function (AMF), and the like. The security network element may implement functions such as subscription data management, user service registration management, generation of an authentication and key agreement (AKA) authentication parameter, subscription data-based access authorization, storage of a root key and authentication-related subscription data of a user, and support of a unified authentication service. The security network element described in this application may further include another network element that can implement a security-related function, for example, a newly defined network element in an evolved network after 5G. For example, the newly defined network element is a homomorphic encryption control function network element.

For another example, the data network element described in this application may include but is not limited to a unified data repository (UDR), an unstructured data storage function (UDSF) network element, a network data analytics function (NWDAF) network element, a data collection coordination function (DCCF) network element, an analytics data repository function (ADRF) network element, and the like. The data network element may implement functions such as data storage and retrieval, event subscription and data collection, information analytics, and information retrieval. In an embodiment, the data network element described in this application may further include another network element that can implement a data-related function, for example, a newly defined network element in an evolved network after 5G. For example, the newly defined network element is a homomorphic encryption party/homomorphic evaluation party/homomorphic decryption party or a ciphertext data storage management unit that is related to this application.

For another example, the management network element described in this application may include but is not limited to a session management function (SMF) network element, a user plane function (UPF) network element, a policy control function (PCF) network element, a network exposure function (NEF) network element, a network slice selection function (NSSF) network element, a network repository function (NRF) network element, a charging function (CHF) network element, a binding support function (BSF) network element, a signaling service processing system (SPS) network element, and the like. The management network element may implement functions such as session management, charging and quality of service policy control, packet routing and forwarding, slice-based policy provision, session-related policy provision, network function information maintenance, data service charging, and protocol data convergence. In an embodiment, the management network element described in this application may further include another network element that can implement a management-related function, for example, a newly defined network element in an evolved network after 5G. For example, the newly defined network element is a key management center or a homomorphic encryption control function network element that is related to this application.

It should be noted that:
“sending” and “receiving” in embodiments of this application represent signal transfer directions. For example, “sending configuration information to a terminal device” may be understood as that a destination end of the configuration information is the terminal device, and may include direct sending through an air interface, or indirect sending by another unit or module through an air interface. “Receiving configuration information from a network device” may be understood as that a source end of the configuration information is the network device, and may include direct receiving from the network device through an air interface, or indirect receiving from the network device from another unit or module through the air interface. “Sending” may alternatively be understood as “outputting” of a chip interface, and “receiving” may alternatively be understood as “inputting” of a chip interface.

In other words, sending and receiving may be performed between devices, for example, between a network device and a terminal device, or may be performed inside a device, for example, sending or receiving between components, modules, chips, software modules, or hardware modules inside the device through a bus, a cable, or an interface.

It may be understood that necessary processing, such as encoding and modulation, may be performed on information between a source end at which the information is sent and a destination end, but the destination end may understand valid information from the source end. Similar descriptions in this application may be understood similarly, and details are not described again.

In embodiments of this application, an “indication” may include a direct indication and an indirect indication, or may include an explicit indication and an implicit indication. Information indicated by a piece of information (for example, the following indication information) is referred to as to-be-indicated information. In an embodiment, the to-be-indicated information may be indicated in a plurality of manners, for example, but not limited to, directly indicating the to-be-indicated information, for example, indicating the to-be-indicated information, an index of the to-be-indicated information, or the like. Alternatively, the to-be-indicated information may be indirectly indicated by indicating other information. There is an association relationship between the other information and the to-be-indicated information. Alternatively, only a part of the to-be-indicated information may be indicated, and the remaining part of the to-be-indicated information is known or pre-agreed on. For example, information may be indicated by using an arrangement sequence of pieces of information that are pre-agreed on (for example, predefined in a protocol), to reduce indication overheads to some extent. An indication manner is not limited in this application. It may be understood that, for a sender of the indication information, the indication information may indicate to-be-indicated information, and for a receiver of the indication information, the indication information may be used to determine to-be-indicated information.

I. For ease of understanding, the following describes in detail definitions of related terms in this application.

### 1. Symmetric Key Architecture Based on a UMTS Subscriber Identity Module (UMTS (Universal Mobile Telecommunications System) Subscriber Identity Module, USIM)

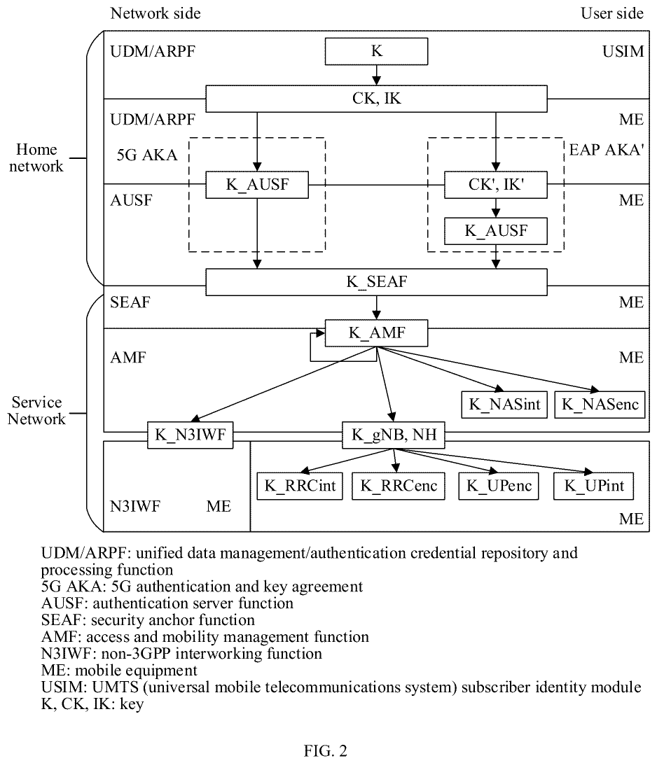

For example, FIG. 2 is a diagram of a key architecture generated based on a key hierarchy in a 5G system. 5G AKA is used as an example. Keys related to identity authentication include but are not limited to the following keys: a K (key), a CK (cipher key), and an IK (integrity key). The key hierarchy includes but is not limited to the following keys: K_AUSF, K_SEAF, K_AMF, K_NASint, K_NASenc, K_N3IWF, K_gNB, K_RRCint, K_RRCenc, K_UPint, and K_UPenc.

For example, for an AUSF key in a home network, in a case of 5G AKA, ME and an ARPF derive K_AUSF from a CK and an IK, and K_AUSF is received from the ARPF as part of a 5G home environment authentication vector (5G HE AV). K_SEAF is an anchor key derived from K_AUSF by the ME and an AUSF. K_SEAF is provided by the AUSF for a security anchor function (SEAF) in a service network.

For example, for an AMF key in a service network, K_AMF is a key derived from K_SEAF by the ME and the SEAF. K_AMF is further derived by the ME and a source AMF when performing horizontal key derivation.

For example, a NAS signaling key includes K_NASint and K_NASenc. K_NASint is a key derived from K_AMF by the ME and the AMF. The key is used only to protect NAS signaling by using an integrity algorithm. K_NASenc is a key derived from K_AMF by the ME and the AMF, and is used only to protect NAS signaling by using an encryption algorithm.

For example, K_gNB (access network key) is a key derived from K_AMF by the ME and the AMF. K_gNB is further derived by the ME and a source gNB when performing horizontal or vertical key derivation. The use of K_gNB is similar to the use of K_eNB between the ME and an ng-eNB. A next hop (NH) is used for vertical derivation of a base station key.

For example, a key for user plane (UP) transmission includes K_UPenc, K_UPint, and the like. K_UPenc is a key derived from K_gNB by the ME and the gNB, and is used to protect data in the UP transmission by using an encryption algorithm. K_UPint is a key derived from K_gNB by the ME and the gNB. The key is used only to protect UP traffic between the ME and the gNB by using an integrity algorithm.

For example, an RRC signaling key includes K_RRCint, K_RRCenc, and the like. K_RRCint is a key derived from K_gNB by the ME and the gNB. The key is used to protect radio resource control (RRC) signaling by using an integrity algorithm. K_RRCenc is a key derived from K_gNB by the ME and the gNB. The key is used to protect RRC signaling by using am encryption algorithm.

For example, K_N3IWF (a non-3GPP interworking function (N3IWF) key) is a key derived from K_AMF by the ME and the AMF for non-3GPP access. It should be noted that K_N3IWF is not forwarded between N3IWFs.

### 2. Homomorphic Encryption (HE)

The homomorphic encryption is intended to complete computation processing on a ciphertext of data without exposing a plaintext of the data, and focuses on privacy-preserving computation. The homomorphic encryption is a technology that can implement data value mining while providing privacy protection. In an embodiment, the homomorphic encryption is an encryption scheme in which an operation can be directly performed on a ciphertext. The homomorphic encryption is based on basic encryption, and a function of homomorphic evaluation on a ciphertext is added. Moreover, a computation result obtained by decrypting a ciphertext evaluation result is consistent with as a plaintext computation result. For example, ciphertext data is obtained by encrypting plaintext data by using a homomorphic encryption key, evaluation processing is performed on the ciphertext data by using a homomorphic evaluation key to obtain a ciphertext evaluation result, and then homomorphic decryption is performed on the ciphertext evaluation result by using a homomorphic decryption key to obtain an output result, where the output result is the same as an output result obtained by computing unencrypted plaintext data by using the same method.

A homomorphic encryption algorithm undergoes a plurality of generations of evolution, including, for example, a multiplicatively homomorphic encryption algorithm and a fully homomorphic encryption algorithm (which enables any quantity of additively and multiplicatively homomorphic operations on a ciphertext, and proposes an important concept bootstrapping). Bootstrapping is a special processing technique for a ciphertext, may convert a high-noise ciphertext into a new low-noise ciphertext, and is key to a BFV (Brakerski, Fan, Vercauteren) homomorphic encryption scheme and a BGV (Brakerski, Gentry, Vaikuntanathan) homomorphic encryption scheme (both of which use key-switching and modulus-switching technologies to reduce a dimension and noise magnitude of a ciphertext, thereby reducing computational complexity of decryption), a CKKS (Cheon, Andrey Kim, Miran Kim, Yongsoo Song) homomorphic encryption scheme (which enables approximate computation to be performed based on the BGV scheme, and supports addition, subtraction, and multiplication operations on a floating-point vector in ciphertext space while maintaining homomorphism), a fully homomorphic encryption scheme over the torus (TFHE), and the like. Fully homomorphic encryption may be asymmetric key encryption or symmetric key encryption, provided that a ciphertext has an algebraic structure.

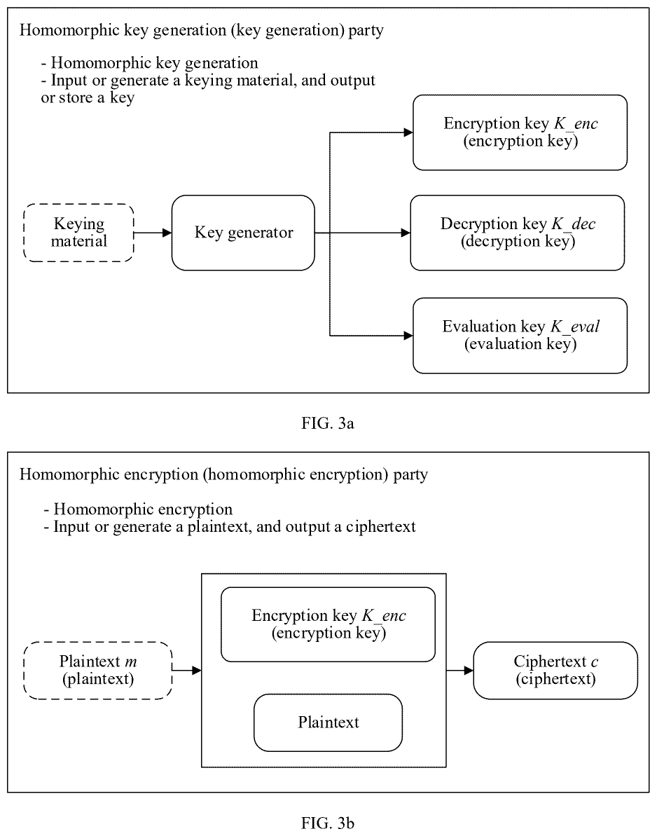

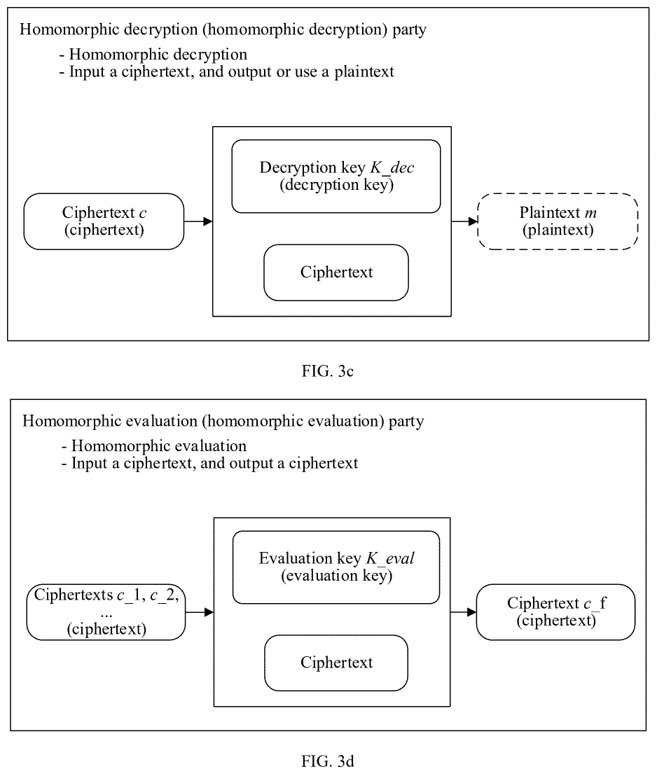

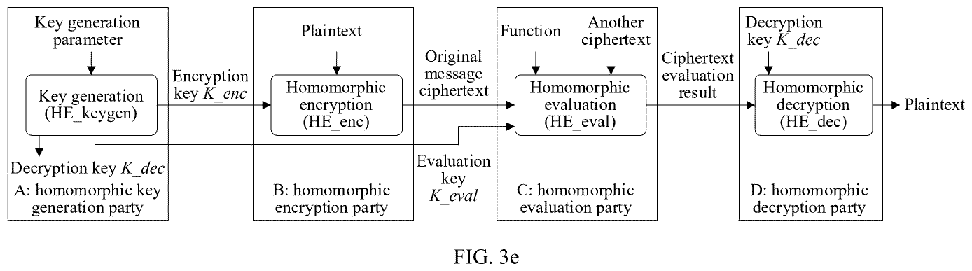

For example, FIG. 3a to FIG. 3e are diagrams of a homomorphic encryption scheme. The scheme includes four algorithms, and an asymmetric cryptography scheme is used as an example for description.

Part 1: Homomorphic key generation party. The homomorphic key generation party may output a public key (PK) as a homomorphic encryption key K_enc=pk, a homomorphic evaluation key K_eval=evk (homomorphic evaluation key, evk), which may also be referred to as a homomorphic evaluation key, and a secret key (SK) as a homomorphic decryption key K_dec=sk, as shown in FIG. 3a.

Part 2: Homomorphic encryption party. The homomorphic encryption party encrypts a single-bit plaintext message m∈{0,1} into a ciphertext c by using the homomorphic encryption key K_enc=pk, as shown in FIG. 3b.

Part 3: Homomorphic decryption party. The homomorphic decryption party decrypts the ciphertext c by using the homomorphic decryption key K_dec=sk, to recover the plaintext message m∈{0, 1}, as shown in FIG. 3c.

Part 4: Homomorphic evaluation party, which may also be referred to as a homomorphic evaluation party. Based on input ciphertexts c_1, c_2, . . . , and the homomorphic evaluation key K_eval=evk, the homomorphic evaluation party performs a homomorphic evaluation function f:{0,1}^{l}→{0,1} on the ciphertexts, to obtain an output ciphertext c_f of homomorphic evaluation, as shown in FIG. 3d.

Therefore, the entire homomorphic encryption scheme HE=(HE_keygen, HE_enc, HE_dec, HE_eval) is shown in FIG. 3e. A homomorphic key generation party A generates a homomorphic encryption key K_enc, a homomorphic evaluation key K_eval, and a homomorphic decryption key K_dec, and needs to distribute the keys to a homomorphic encryption party B, a homomorphic evaluation party C, and a homomorphic decryption party D respectively. The homomorphic encryption party B encrypts a plaintext by using the homomorphic encryption key K_enc. The homomorphic evaluation party C performs evaluation on a ciphertext by using the homomorphic evaluation key K_eval, to obtain a ciphertext evaluation result. The homomorphic decryption party D decrypts the ciphertext evaluation result by using the homomorphic decryption key K_dec. A plaintext obtained through decryption is equivalent to a plaintext computation result.

### 3. Symmetric Cryptography and Asymmetric Cryptography

(1) Symmetric cryptography, also referred to as private key cryptography. That is, a sender and a receiver of information use a same key to encrypt and decrypt data (that is, an encryption party and a decryption party use a same encryption/decryption key). The symmetric cryptography has an advantage of a high encryption/decryption speed, and is suitable for encrypting a large amount of data. The symmetric cryptography usually uses a relatively small key, which is generally less than 256 bits. It should be noted that a size of a key for the symmetric cryptography needs to strike a balance between security and processing efficiency.

(2) Asymmetric cryptography, also referred to as public key cryptography. The asymmetric cryptography uses a pair of keys: a public key and a private key. The private key may be securely kept by only one party, while the public key may be sent to any request party. The asymmetric cryptography uses one of the pair of keys (for example, the public key) for encryption, while decryption requires the other key (for example, the private key). Different from the symmetric cryptography, the private key is not sent. Therefore, security can be improved.

4. Scenario in which there are a Plurality of Parties in a Homomorphic Encryption Task

A wireless network is deployed as a plurality of cells, and each cell has a plurality of terminals accessing a serving cell in which the terminals are located. Terminals configured with an on-board unit (OBU), such as a smart vehicle, a smartphone, a VR/AR device, and a smart camera, may have a homomorphic security capability. When privacy protection is required, sensitive data generated is encrypted and then transmitted to other nodes such as a terminal node, a road side unit (RSU), a base station, a core network element, and a cloud vendor in a communication network; then, homomorphic evaluation is performed on a ciphertext; and finally, ciphertext data obtained through the evaluation is transmitted to a data user for homomorphic decryption and subsequent use. Therefore, there may be a plurality of homomorphic encryption tasks in an entire network, and a communication network can provide privacy protection and a privacy-preserving computation service for a high-security and high-sensitivity service based on a (fully) homomorphic encryption technology.

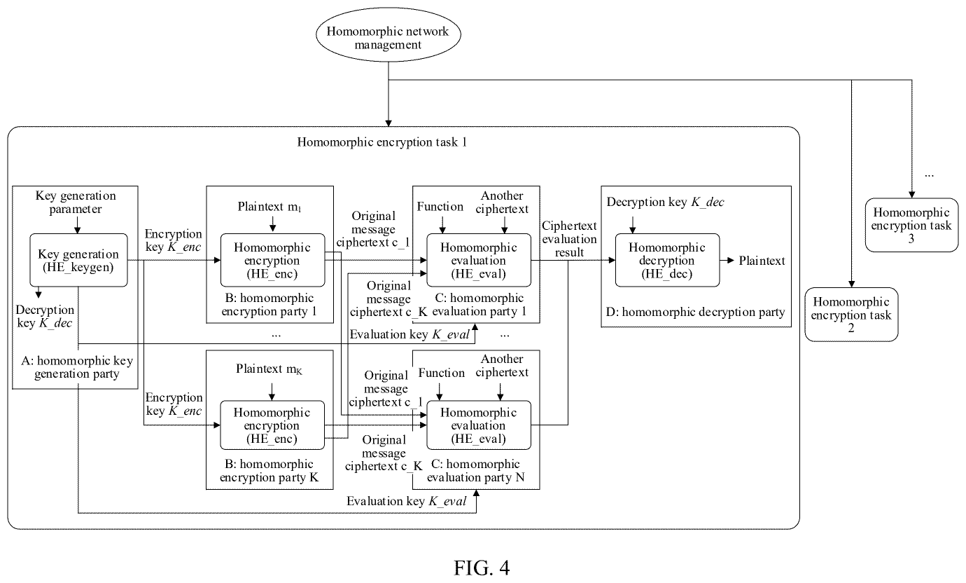

For example, FIG. 4 is a diagram of a network scenario in which there are a plurality of parties in a homomorphic encryption task. It is assumed that in a homomorphic encryption task, K homomorphic encryption parties encrypt data from different sources, and N homomorphic evaluation parties execute a homomorphic evaluation circuit. A homomorphic key generation party needs to distribute a derived homomorphic encryption key K_enc to K homomorphic encryption parties, distribute a homomorphic evaluation key K_eval (for example, a key switching key (KSK) or a bootstrapping key (BSK)) to N homomorphic evaluation parties, and distribute a homomorphic decryption key K_dec to a homomorphic decryption party (FIG. 4 shows only one homomorphic decryption party, and one homomorphic encryption task may alternatively include a plurality of homomorphic decryption parties).

Homomorphic network management in FIG. 4 is also referred to as a homomorphic encryption control function (HECF) network element. The network element may include but is not limited to the following management units.

a. Homomorphic encryption task management (HETM) unit, used to implement the following functions.

(1) Homomorphic task request management: managing all homomorphic task requests. For example, the HETM may receive a homomorphic task request, parse the homomorphic task request, and respond to the homomorphic task based on a homomorphic task scheduling management result. In an embodiment, the HETM may filter out a homomorphic task request that is repeated, improper, or the like.

(2) Homomorphic task scheduling management. For example, the HETM may perform homomorphic task scheduling based on a homomorphic task request parsing result, a homomorphic security capability list of a homomorphic enabled node (HE Enabler), and the like, deliver a homomorphic task configuration to a homomorphic encryption party, a homomorphic evaluation party, and a homomorphic decryption party, and receive a homomorphic task response.

(3) Homomorphic task configuration profile (Profile) management. For example, the HETM may generate a homomorphic task profile (stored in the HETM) based on a homomorphic task request, homomorphic task scheduling, and the like, and perform management such as forwarding, updating, storage, and destruction on the profile.

b. Homomorphic encryption capability management (HECapM) unit, used to implement the following function: homomorphic enabled node profile management. For example, the HECapM may receive homomorphic security capabilities reported by homomorphic parties such as a homomorphic encryption party, a homomorphic decryption party, and a homomorphic evaluation party, and generate, store, and update a homomorphic security capability profile (stored in the HECapM) registered by a node.

c. Homomorphic encryption key management (HEKM) unit, used to implement the following function: key management for a homomorphic task. For example, the HEKM may generate a data encryption/decryption key (a symmetric encryption/decryption key that does not support a homomorphic property, an asymmetric encryption/decryption key, or a homomorphic encryption/decryption key) and a homomorphic evaluation key, and perform management such as distribution, use, update, storage, destruction, and life cycle management of a key.

d. HECF interface management (HEinterM) unit, used to implement the following functions.

(1) Support for cross-domain, hierarchical, and multi-node deployment of HECFs.

(2) Forwarding of information such as a homomorphic security capability profile, a homomorphic encryption task profile, and a homomorphic key parameter of a homomorphic enabled node between HECFs.

e. Ciphertext data storage management (CDSM) unit, used to implement the following functions.

(1) Ciphertext receiving and sending management. For example, the CDSM may receive a ciphertext from a homomorphic enabled node or an encryption party, or send a ciphertext to a homomorphic enabled node or a decryption party.

(2) Ciphertext life cycle management. For example, the CDSM may set a life cycle for each ciphertext, which starts when the ciphertext is received, and delete the ciphertext after the life cycle of the ciphertext ends.

(3) Ciphertext storage management. For example, the CDSM may create different ciphertext storage areas through partitioning. A partitioning granularity may be different users, different keys, different security contexts, different network layers, different service shards, or the like

It should be noted that the homomorphic enabled node may be a node such as a terminal (UE), a base station (radio access network RAN), a core network element, an independent node (IN), or an application function (AF). The homomorphic enabled node may be a homomorphic encryption party, a homomorphic evaluation party, or a homomorphic decryption party.

### 5. Security Protection at a Non-Access Stratum (NAS) and an Access Stratum (AS)

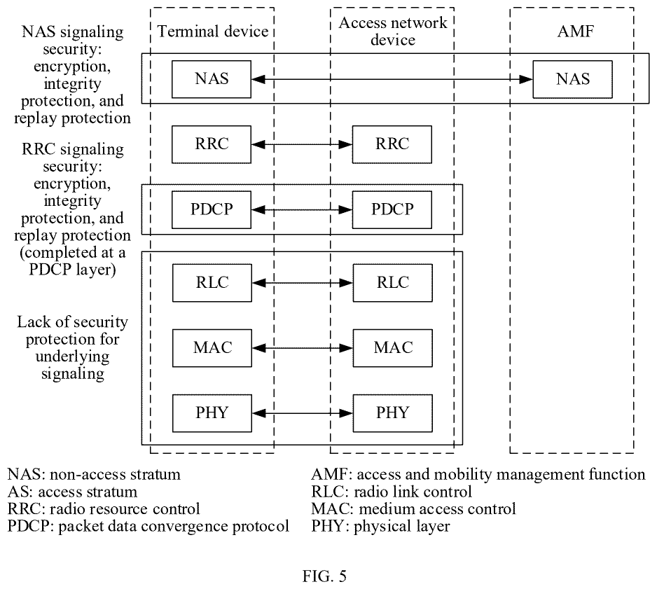

Similar to 4G, a 5G system has a feature of dual-layer security, and security mode command activation and security protection are performed separately at a NAS layer and an AS layer. For example, FIG. 5 is a diagram of a wireless network protocol layer, mainly showing security protection at a NAS layer, a packet data convergence protocol (PDCP) layer, and an AS layer. After UE and a network authenticate each other, the UE and the network need to negotiate a security algorithm and a key used for encryption and integrity protection of RRC/NAS signaling and user data in a subsequent communication process. For example, after negotiation of a NAS security algorithm is completed, encryption and integrity protection are performed on all NAS messages between an AMF and the UE. In an AS security mode command interaction process, a gNodeB and the UE negotiate a key algorithm and a key for AS encryption and integrity protection, and enable encryption and integrity protection for an RRC message and user data at the AS layer. RRC signaling security is implemented at the PDCP layer. Encryption and integrity protection of existing 4G and 5G use a symmetric key algorithm. A control plane protocol stack of 5G NR is the same as that of 4G LTE, as shown in FIG. 5. All protocol stacks of the UE are located in the UE. On a network side, a NAS layer is not located in a base station gNB, but in an AMF entity of a core network. In an embodiment, there is no security protection at the PDCP layer and protocol sublayers below the PDCP layer.

### 6. Signaling Interaction Between a Terminal Side and a Network Side

For example, a signaling interaction procedure between a terminal and a network side in an initial access phase may include several phases: cell selection, random access, RRC connection establishment, security authentication, and bearer establishment.

a. Cell selection: The terminal first selects a cell in the initial access phase. For example, the terminal receives information such as a primary synchronization signal (PSS), a secondary synchronization signal (PSS), or system information (for example, a master information block (MIB) and a system information block (SIB)), to obtain configuration information of a cell, so that the terminal may work normally after accessing the cell.

b. Random access: After selecting the cell, the terminal initiates random access to the corresponding cell. For example, the terminal sends a random access request message to an access network device, and the access network device feeds back a random access response message to the terminal.

c. RRC connection establishment: After initiating the random access, the terminal may initiate RRC connection establishment. For example, the terminal sends an RRC connection establishment request message to the access network device, and the access network device feeds back an RRC connection establishment response message to the terminal (for example, the access network device feeds back RRCSetupComplete signaling, indicating that an RRC connection is successfully established).

d. Security authentication: The terminal side and the network side perform bidirectional identity authentication, and initiate key derivation and negotiation at a NAS layer and an AS layer after the authentication succeeds. It should be noted that before NAS security and AS security are established, no security protection is provided for all air interface signaling, including RRC signaling and NAS signaling. After a NAS security mode complete (NAS SMC) procedure, encryption and integrity protection are enabled for the NAS signaling. After an AS security mode complete (AS SMC) procedure, encryption and integrity protection are enabled for the RRC signaling.

e. Bearer establishment: For example, the terminal and the access network device establish a data resource bearer (DRB) through an RRC reconfiguration process. The access network device and the terminal activate corresponding user plane encryption and integrity protection. However, still no security protection is provided for layer 1 (L1) signaling, layer 2 (L2) signaling, and other data.

II. User-Level Homomorphic Encryption Management Method Provided in this Application

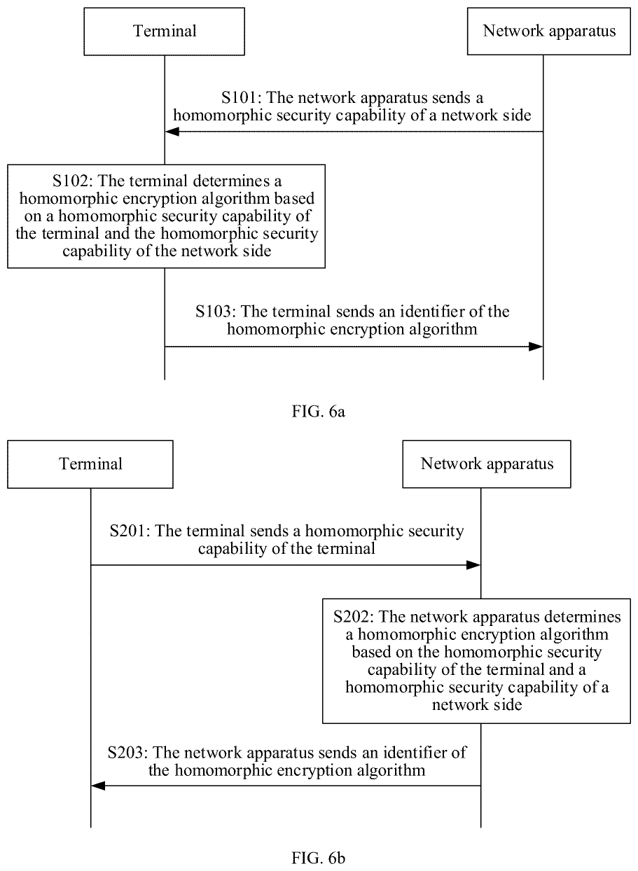

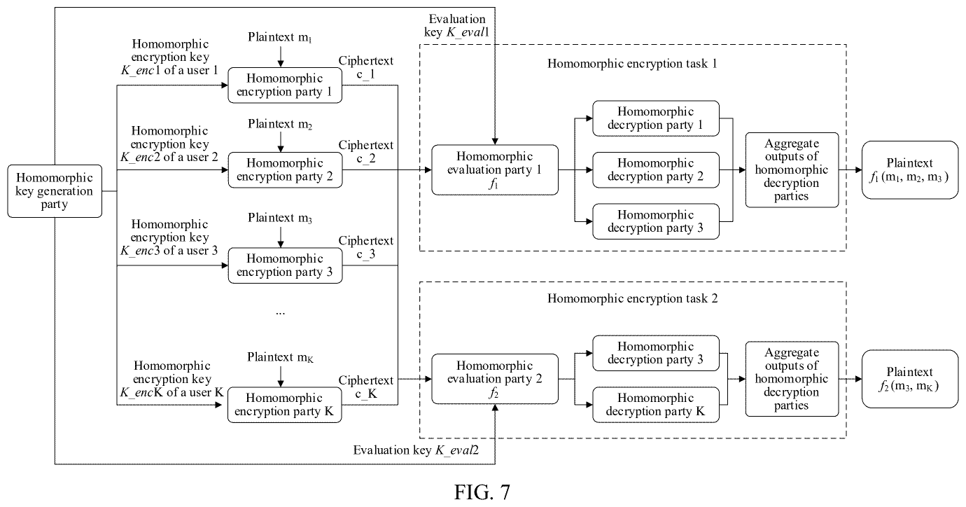

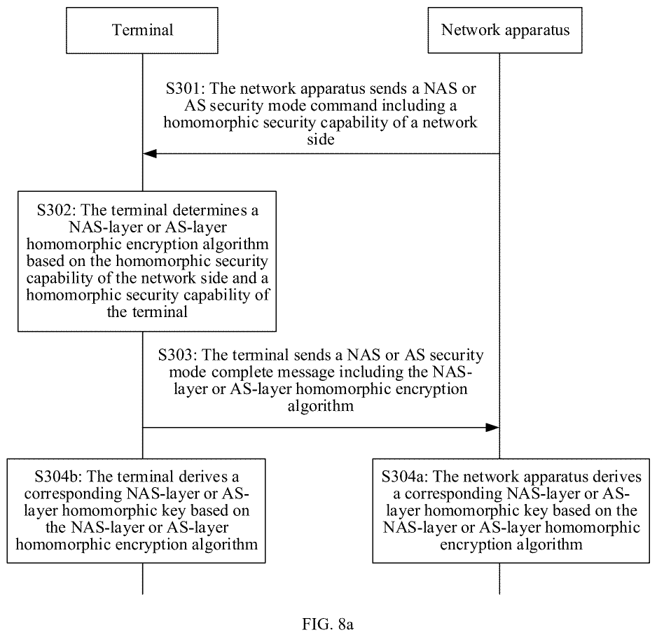

For example, FIG. 6a and FIG. 6b are schematic flowcharts of a user-level homomorphic encryption management method according to this application. The user-level homomorphic encryption management method may be applied to the communication system shown in FIG. 1. In an embodiment, the user-level homomorphic encryption management method may be applied to a network scenario in which there are a plurality of parties in a homomorphic encryption task shown in FIG. 7. It is assumed that in the network scenario shown in FIG. 7, K homomorphic encryption parties (for example, homomorphic encryption parties 1 to K) encrypt data from different sources (for example, respectively encrypt plaintext messages of users 1 to K), two homomorphic evaluation parties (for example, a homomorphic evaluation party 1 and a homomorphic evaluation party 2) execute a homomorphic evaluation circuit, and K homomorphic decryption parties (for example, homomorphic decryption parties 1 to K) decrypt ciphertext data. In addition, it is assumed that there are two homomorphic encryption tasks (for example, a homomorphic encryption task 1 and a homomorphic encryption task 2) in the network scenario, and a homomorphic decryption party 3 participates in both the homomorphic encryption task 1 and the homomorphic encryption task 2. The ciphertext data may be transferred between different homomorphic encryption tasks (for example, a homomorphic decryption key and ciphertext data of the homomorphic decryption party 3 may be reused by the homomorphic encryption tasks 1 and 2).

Example 1: The user-level homomorphic encryption management method may be implemented through interaction between a terminal and a network apparatus, and the terminal determines a homomorphic encryption algorithm, as shown in FIG. 6a. In an embodiment, the network apparatus includes an access network device and/or a core network element. The user-level homomorphic encryption management method includes the following operations.

S101: The network apparatus sends a homomorphic security capability of a network side, and correspondingly, the terminal receives the homomorphic security capability of the network side.

The homomorphic security capability of the network side indicates a capability of the network side to execute a homomorphic encryption task. For example, when the network side is a homomorphic encryption party, the homomorphic security capability of the network side includes a homomorphic encryption algorithm that may be selected by the network side.

In an embodiment, the network side is not necessarily a homomorphic encryption party. A homomorphic enabled unit is used as an example. A homomorphic security capability of the homomorphic enabled unit may include but is not limited to one or more of the following parameters: a type of homomorphic enabled unit (for example, a base station, a terminal, a network element, or an independent node), an identifier (for example, an ID of a node such as a base station, a terminal, a network element, or an independent node), a homomorphic encryption capability level (for example, partially homomorphic encryption, quasi-homomorphic encryption, leveled homomorphic encryption, or fully homomorphic encryption), a homomorphic encryption security level (for example, 128-bit or 256-bit security strength), a homomorphic encryption enable flag (for example, a flag True indicates that a homomorphic encryption function is enabled, and a flag false indicates that a homomorphic encryption function is disabled), a homomorphic decryption enable flag (for example, a flag True indicates that a homomorphic decryption function is enabled, and a flag false indicates that a homomorphic decryption function is disabled), a homomorphic evaluation enable flag (for example, a flag True indicates that a homomorphic evaluation function is enabled, and a flag false indicates that a homomorphic evaluation function is disabled), identifiers of supported homomorphic encryption algorithms (for example, an additive partially homomorphic encryption algorithm Paillier, a multiplicative partially homomorphic encryption algorithm ElGamal or RSA, a quasi-homomorphic encryption algorithm BGN 05, and fully homomorphic encryption algorithms BGV, BFV, CKKS, TFHE, and the like), an identifier of a supported homomorphic evaluation algorithm (for example, a machine learning algorithm (including a convolutional neural network (CNN), a recurrent neural network (RNN), a generative adversarial network (GAN), a support vector machine (SVM), and the like)), and the like.

S102: The terminal determines a homomorphic encryption algorithm based on a homomorphic security capability of the terminal and the homomorphic security capability of the network side.

For example, the homomorphic encryption algorithm applicable to this application may include but is not limited to the additive partially homomorphic encryption algorithm Paillier, the multiplicative partially homomorphic encryption algorithm ElGamal or RSA, the quasi-homomorphic encryption algorithm BGN 05, and the fully homomorphic encryption algorithms BGV, BFV, CKKS, TFHE, and the like.

S103: The terminal sends an identifier of the homomorphic encryption algorithm, and correspondingly, the network apparatus receives the identifier of the homomorphic encryption algorithm.

The terminal comprehensively considers respective homomorphic security capabilities of a terminal side and the network side, so as to select a homomorphic encryption algorithm applicable to both the terminal side and the network side. For example, the terminal determines a homomorphic encryption algorithm based on homomorphic capability information of the terminal and the homomorphic security capability of the network side.

In an embodiment, after determining a homomorphic encryption algorithm, the terminal may send an identifier of the homomorphic encryption algorithm to the access network device and/or the core network element, so that the terminal and the network side derive a homomorphic key by using the same homomorphic encryption algorithm. This helps correctly execute a homomorphic task.

Example 2: The user-level homomorphic encryption management method may be implemented through interaction between a terminal and a network apparatus, and the network apparatus determines a homomorphic encryption algorithm, as shown in FIG. 6b. In an embodiment, the network apparatus includes an access network device and/or a core network element. The user-level homomorphic encryption management method includes the following operations.

S201: The terminal sends a homomorphic security capability of the terminal, and correspondingly, the network apparatus receives the homomorphic security capability of the terminal.

The homomorphic security capability of the terminal indicates a capability of the terminal to execute a homomorphic encryption task. For example, the homomorphic security capability of the terminal includes a homomorphic encryption algorithm that may be selected by the terminal, and the like.

S202: The network apparatus determines a homomorphic encryption algorithm based on the homomorphic security capability of the terminal and a homomorphic security capability of a network side.

S203: The network apparatus sends an identifier of the homomorphic encryption algorithm, and correspondingly, the terminal receives the identifier of the homomorphic encryption algorithm.

The network side comprehensively considers respective homomorphic security capabilities of a terminal side and the network side, so as to select a homomorphic encryption algorithm applicable to both the terminal side and the network side. In an embodiment, refer to descriptions of operations S102 and S103 performed by the terminal. Details are not described herein again.

In the foregoing two examples, the terminal or the network side may determine the homomorphic encryption algorithm by comprehensively considering the homomorphic security capabilities of the terminal side and the network side. This helps the terminal provide user-level high privacy protection strength.

III. The following describes in detail procedures of Example 1 and Example 2 in Part II.

1. A procedure of Example 1: Based on the foregoing description in Example 1, if the terminal determines the homomorphic encryption algorithm, the network apparatus sends the homomorphic security capability of the network side to the terminal. Message exchange between the terminal and the network apparatus has security and integrity protection. In an embodiment, message exchange in Example 1 may be included in a NAS SMC or AS SMC procedure, or may be performed after a NAS SMC or AS SMC procedure.

Implementation 1: In a NAS SMC or AS SMC procedure, a terminal determines a homomorphic encryption algorithm.

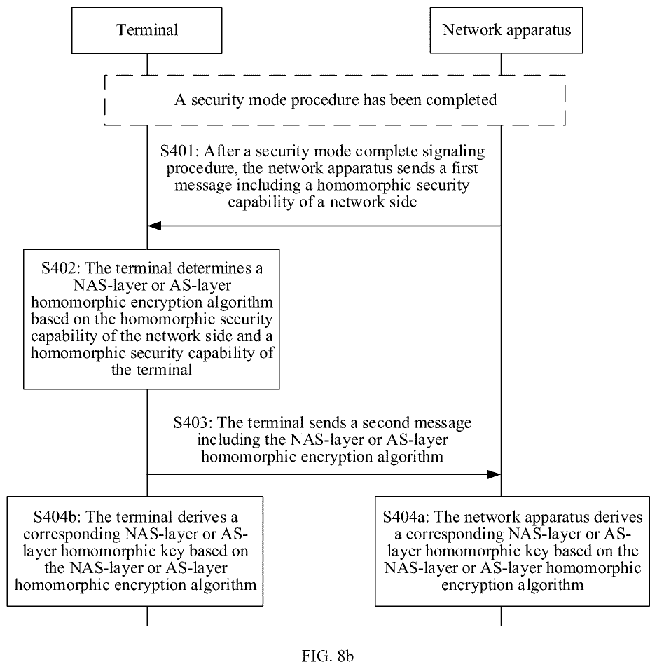

For example, FIG. 8a is a schematic flowchart of determining a homomorphic encryption algorithm by a terminal in a security mode complete procedure according to this application. The method is implemented through interaction between a terminal and a network apparatus, and includes the following operations.

S301: The network apparatus sends a NAS or AS security mode command, where the NAS or AS security mode command includes a homomorphic security capability of a network side, and correspondingly, the terminal receives the NAS or AS security mode command.

For example, a core network element or an access network device sends a NAS security mode command to the terminal, where the NAS security mode command carries a homomorphic security capability of the core network element or a homomorphic security capability of the access network device.

S302: The terminal determines a NAS-layer or AS-layer homomorphic encryption algorithm based on the homomorphic security capability of the network side and a homomorphic security capability of the terminal.

S303: The terminal sends a NAS or AS security mode complete message, where the security mode complete message includes the NAS-layer or AS-layer homomorphic encryption algorithm, and correspondingly, the network apparatus receives the NAS or AS security mode complete message.

For example, the terminal sends a NAS security mode complete message to the network apparatus, where the message carries a NAS-layer homomorphic encryption algorithm determined by the terminal by comprehensively considering respective homomorphic security capabilities of the network side and the terminal. In an embodiment, the message may further include a life cycle of a homomorphic key.

S304a: The network apparatus derives a corresponding NAS-layer or AS-layer homomorphic key based on the NAS-layer or AS-layer homomorphic encryption algorithm.

S304b: The terminal derives a corresponding NAS-layer or AS-layer homomorphic key based on the NAS-layer or AS-layer homomorphic encryption algorithm.

For example, the network apparatus and the terminal may separately derive, based on the NAS-layer or AS-layer homomorphic encryption algorithm, their respective NAS-layer or AS-layer homomorphic keys. A sequence of performing S304a and S304b is not limited in this application. For example, S304a may be performed before S304b, or S304b may be performed before S304a, or S304a and S304b may be simultaneously performed.

Implementation 2: After a NAS SMC or AS SMC procedure, a terminal determines a homomorphic encryption algorithm.

For example, FIG. 8b is a schematic flowchart of determining a homomorphic encryption algorithm by a terminal after a security mode complete procedure according to this application. The method is implemented through interaction between a terminal and a network apparatus, and includes the following operations.

S401: After a security mode complete procedure, the network apparatus sends a first message, where the first message includes a homomorphic security capability of a network side, and correspondingly, the terminal receives the first message.

For example, the network apparatus may send a first message (for example, other NAS or RRC signaling with confidentiality and integrity protection) to the terminal after receiving a NAS or AS security mode complete message, where the first message carries a homomorphic security capability of a core network element or a homomorphic security capability of an access network device.

S402: The terminal determines a NAS-layer or AS-layer homomorphic encryption algorithm based on the homomorphic security capability of the network side and a homomorphic security capability of the terminal.

S403: The terminal sends a second message, where the second message includes the NAS-layer or AS-layer homomorphic encryption algorithm, and correspondingly, the network apparatus receives the second message.

For example, the terminal may send a second message (for example, other NAS or RRC signaling with confidentiality and integrity protection) to the network apparatus after sending a NAS or AS security mode complete message, where the second message carries the NAS-layer or AS-layer homomorphic encryption algorithm, to notify the network side of the corresponding NAS-layer or AS-layer homomorphic encryption algorithm.

S404a: The network apparatus derives a corresponding NAS-layer or AS-layer homomorphic key based on the NAS-layer or AS-layer homomorphic encryption algorithm.

S404b: The terminal derives a corresponding NAS-layer or AS-layer homomorphic key based on the NAS-layer or AS-layer homomorphic encryption algorithm.

For example, the network apparatus and the terminal may separately derive, based on the NAS-layer or AS-layer homomorphic encryption algorithm, their respective NAS-layer or AS-layer homomorphic keys. A sequence of performing S404a and S404b is not limited in this application. For example, S404a may be performed before S404b, or S404b may be performed before S404b, or S404a and S404b may be simultaneously performed.

2. A procedure of Example 2: Based on the foregoing description in Example 2, if the network apparatus determines the homomorphic encryption algorithm, the terminal reports the homomorphic security capability of the terminal to the network apparatus. Message exchange between the terminal and the network apparatus requires security and integrity protection. In an embodiment, message exchange in Example 2 may be included in a NAS SMC or AS SMC procedure, or may be performed after a NAS SMC or AS SMC procedure.

Implementation 3: In a NAS SMC or AS SMC procedure, a network apparatus determines a homomorphic encryption algorithm.

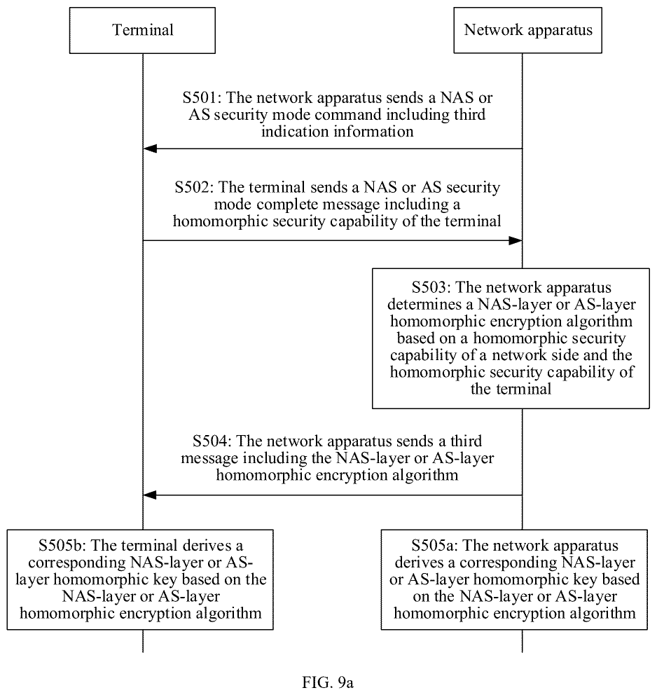

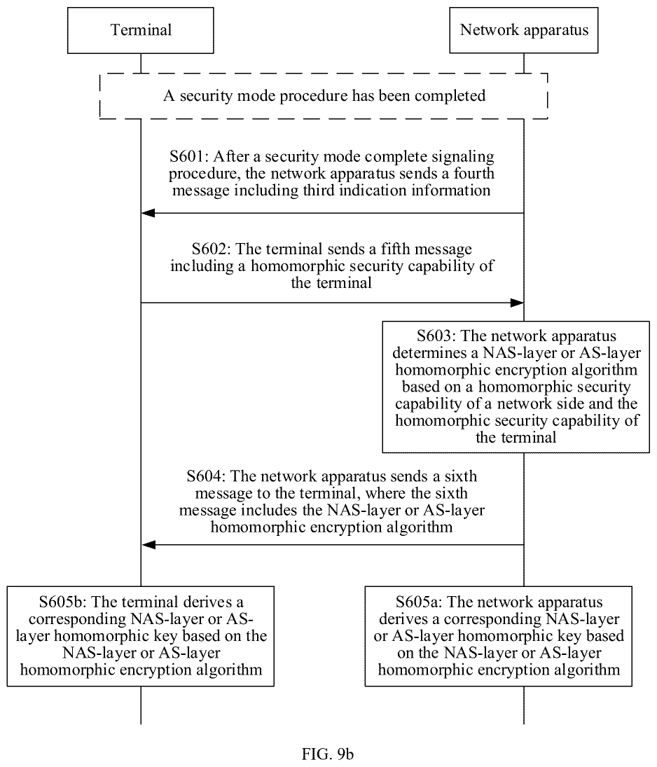

For example, FIG. 9a is a schematic flowchart of determining a homomorphic encryption algorithm by a network apparatus in a security mode complete procedure according to this application. The method is implemented through interaction between a terminal and a network apparatus, and includes the following operations.

S501: The network apparatus sends a NAS or AS security mode command, where the NAS or AS security mode command includes third indication information, and correspondingly, the terminal receives the NAS or AS security mode command.

For example, the third indication information indicates to obtain a homomorphic security capability of the terminal. In other words, the network apparatus needs to obtain the homomorphic security capability of the terminal.

S502: The terminal sends a NAS or AS security mode complete message, where the NAS or AS security mode complete message includes the homomorphic security capability of the terminal, and correspondingly, the network apparatus receives the NAS or AS security mode complete message.

For example, after receiving the third indication information, the terminal may feed back the homomorphic security capability of the terminal in the NAS or AS security mode complete message.

S503: The network apparatus determines a NAS-layer or AS-layer homomorphic encryption algorithm based on a homomorphic security capability of a network side and the homomorphic security capability of the terminal.

S504: The network apparatus sends a third message, where the third message includes the NAS-layer or AS-layer homomorphic encryption algorithm, and correspondingly, the terminal receives the third message.

For example, the network apparatus may include the NAS-layer or AS-layer homomorphic encryption algorithm in other NAS or RRC signaling with confidentiality and integrity protection after receiving the NAS or AS security mode complete message, to notify the terminal of the corresponding NAS-layer or AS-layer homomorphic encryption algorithm.

S505a: The network apparatus derives a corresponding NAS-layer or AS-layer homomorphic key based on the NAS-layer or AS-layer homomorphic encryption algorithm.

S505b: The terminal derives a corresponding NAS-layer or AS-layer homomorphic key based on the NAS-layer or AS-layer homomorphic encryption algorithm.

For example, the network apparatus and the terminal may separately derive, based on the NAS-layer or AS-layer homomorphic encryption algorithm, their respective NAS-layer or AS-layer homomorphic keys. A sequence of performing S505a and S505b is not limited in this application. For example, S505a may be performed before S505b, or S505b may be performed before S505a, or S505a and S505b may be simultaneously performed.

Implementation 4: After a NAS SMC or AS SMC procedure, a network apparatus determines a homomorphic encryption algorithm.

For example, FIG. 9b is a schematic flowchart of determining a homomorphic encryption algorithm by a network apparatus after a security mode complete procedure according to this application. The method is implemented through interaction between a terminal and a network apparatus, and includes the following operations.

S601: After a security mode complete procedure, the network apparatus sends a fourth message, where the fourth message includes third indication information, and correspondingly, the terminal receives the fourth message.

For example, the third indication information indicates to obtain a homomorphic security capability of the terminal. In other words, the network apparatus needs to obtain the homomorphic security capability of the terminal.

S602: The terminal sends a fifth message, where the fifth message includes the homomorphic security capability of the terminal, and correspondingly, the network apparatus receives the fifth message.

For example, after receiving the third indication information, the terminal may feed back the homomorphic security capability of the terminal by using other NAS or RRC signaling with confidentiality and integrity protection.

S603: The network apparatus determines a NAS-layer or AS-layer homomorphic encryption algorithm based on a homomorphic security capability of a network side and the homomorphic security capability of the terminal.

S604: The network apparatus sends a sixth message to the terminal, where the sixth message includes the NAS-layer or AS-layer homomorphic encryption algorithm, and correspondingly, the terminal receives the sixth message.

For example, the network apparatus may include the NAS-layer or AS-layer homomorphic encryption algorithm in other NAS or RRC signaling with confidentiality and integrity protection after receiving the NAS or AS security mode complete message, to notify the terminal of the corresponding NAS-layer or AS-layer homomorphic encryption algorithm.

S605a: The network apparatus derives a corresponding NAS-layer or AS-layer homomorphic key based on the NAS-layer or AS-layer homomorphic encryption algorithm.

S605b: The terminal derives a corresponding NAS-layer or AS-layer homomorphic key based on the NAS-layer or AS-layer homomorphic encryption algorithm.

For example, the network apparatus and the terminal may separately derive, based on the NAS-layer or AS-layer homomorphic encryption algorithm, their respective NAS-layer or AS-layer homomorphic keys. A sequence of performing S605a and S605b is not limited in this application. For example, S605a may be performed before S605b, or S605b may be performed before S605a, or S605a and S605b may be simultaneously performed.

In an embodiment, for the foregoing implementations 1 to 4, the network apparatus and the terminal may separately derive, based on the homomorphic encryption algorithm, their respective homomorphic keys. For example, the terminal or the network apparatus determines a homomorphic encryption key and/or a homomorphic decryption key based on the homomorphic encryption algorithm, where the homomorphic encryption key is used to encrypt a plaintext message into a first ciphertext, and the homomorphic decryption key is used to decrypt a second ciphertext obtained through homomorphic evaluation into a plaintext message. In this application, a user-level homomorphic encryption key or a user-level homomorphic decryption key or both are decoupled from a homomorphic encryption task. For example, a life cycle of the user-level homomorphic encryption key and/or homomorphic decryption key is unrelated to duration of the homomorphic encryption task. The life cycle of the user-level homomorphic encryption key and/or homomorphic decryption key may be within time between successful establishment and completion of release of a radio resource control RRC connection of a user. That is, the life cycle of the user-level homomorphic encryption key and/or homomorphic decryption key is within a time period between successful derivation of a user-level homomorphic encryption/decryption key of a user and destruction of the homomorphic encryption/decryption key, where the user is a homomorphic encryption party or a homomorphic decryption party.

In an embodiment, for the foregoing implementations 1 to 4, after the network apparatus and the terminal separately derive their respective homomorphic encryption keys and/or homomorphic decryption keys, the network apparatus and the terminal may further separately store the first ciphertext and key information corresponding to the first ciphertext, and/or the second ciphertext and key information corresponding to the second ciphertext. The key information includes one or more of a homomorphic encryption key, a homomorphic decryption key, a homomorphic evaluation key, a key derivation parameter, and a security context. For example, if the network apparatus and the terminal are homomorphic encryption parties, the network apparatus and the terminal may separately encrypt the plaintext message based on their respective homomorphic encryption keys, to obtain the first ciphertext. To enable ciphertext data (for example, the first ciphertext and/or the second ciphertext) to be repeatedly used in a communication network for a plurality of times, the ciphertext data needs to be stored together with a corresponding homomorphic key, key derivation parameter, homomorphic security context, and the like. It should be noted that the key information is an encryption/decryption key or a key-related parameter corresponding to encryption of the stored ciphertext data, and is not related to an RRC state of the terminal.

In an embodiment, in addition to the operations in the foregoing implementations 1 to 4, the user-level homomorphic encryption management method provided in this application may further include the following procedures.

### 3. Key Derivation for a Homomorphic Evaluation Key

After a homomorphic encryption task is created, the terminal or the network apparatus may receive a homomorphic evaluation key, where the homomorphic evaluation key is used by one or more homomorphic evaluation parties in the homomorphic encryption task to perform homomorphic evaluation on the first ciphertext, so as to output the second ciphertext. The homomorphic evaluation key may be a homomorphic key derived based on a USIM symmetric key architecture or a key management center (KMC) independent key architecture. It should be noted that the homomorphic evaluation key in this application is coupled to the homomorphic encryption task. For example, a life cycle of the homomorphic evaluation key is duration of the homomorphic encryption task.

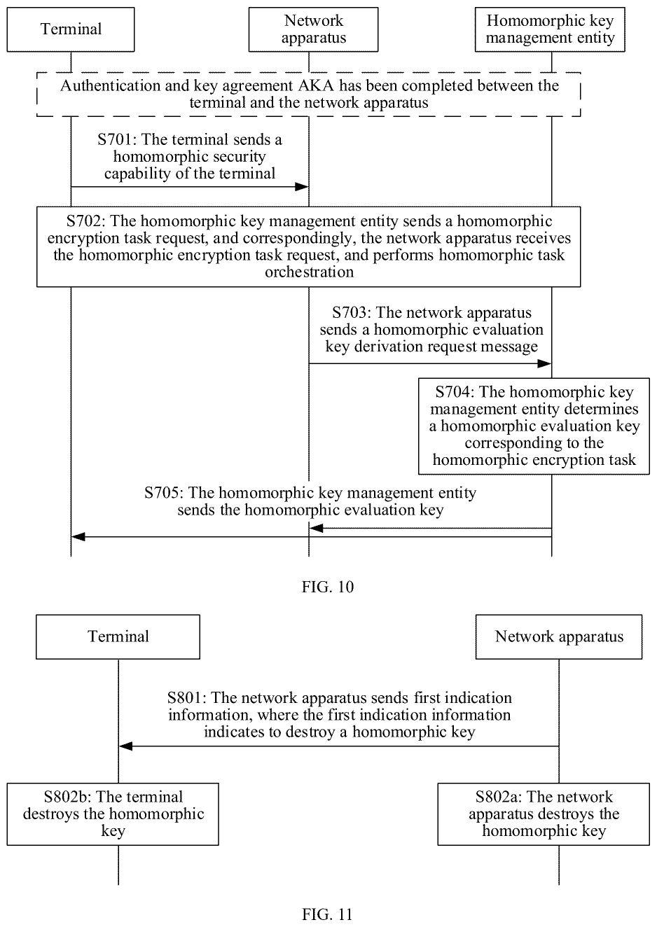

For example, FIG. 10 is a schematic flowchart of key derivation for a homomorphic evaluation key according to this application. The procedure is implemented through interaction between parties (including, for example, a terminal and a network apparatus) of a homomorphic task and a homomorphic key management entity (for example, homomorphic key management based on the USIM symmetric key architecture or the KMC independent key architecture), and includes the following operations.

S701: The terminal sends a homomorphic security capability of the terminal, and correspondingly, the network apparatus receives the homomorphic security capability of the terminal.

In an embodiment, before S701, authentication and key agreement AKA has been completed between the terminal and the network apparatus.

S702: The homomorphic key management entity sends a homomorphic encryption task request, and correspondingly, the network apparatus receives the homomorphic encryption task request, and performs homomorphic task orchestration.

For example, the network apparatus receives a homomorphic encryption task request message from a homomorphic task request party, where the homomorphic encryption task request message includes a type of a requested homomorphic encryption task (for example, artificial intelligence (AI) training/inference or data compression), a type of an output result of a homomorphic encryption task (for example, an AI model parameter, sensing data, or a control instruction), or the like. The network apparatus may perform homomorphic task orchestration (for example, determining a homomorphic encryption party, a homomorphic evaluation party, and a homomorphic decryption party) based on the request message.

S703: The network apparatus sends a homomorphic evaluation key derivation request message, and correspondingly, the homomorphic key management entity receives the homomorphic evaluation key derivation request message.

S704: The homomorphic key management entity determines a homomorphic evaluation key corresponding to the homomorphic encryption task.

For example, the homomorphic evaluation key derivation request message is used to request the homomorphic key management entity to derive a corresponding homomorphic evaluation key for the homomorphic encryption task. After receiving the homomorphic evaluation key derivation request message, the homomorphic key management entity may derive, based on a type of an output result of a requested homomorphic encryption task, a homomorphic encryption/decryption key, and the like, the homomorphic evaluation key corresponding to the homomorphic encryption task.

S705: The homomorphic key management entity sends the homomorphic evaluation key, and correspondingly, the terminal and the network apparatus receive the homomorphic evaluation key.

For example, it is assumed that in the homomorphic encryption task, homomorphic evaluation parties include the terminal and an access network device. In this case, the homomorphic key management entity may send the homomorphic evaluation key to both the terminal and the network apparatus.

### 4. Destruction of a Homomorphic Key

When a life cycle of a homomorphic key ends, both the terminal and the network apparatus destroy the homomorphic key. In an embodiment, whether the life cycle ends is determined based on an RRC connection state of the terminal. For example, when the RRC connection state of the terminal changes, for example, UE enters an idle state, it is determined that the life cycle of the homomorphic key ends, and the terminal and the network apparatus destroy their respective homomorphic keys. In an embodiment, if an RRC message (for example, an RRC release message or other RRC signaling) or a NAS message sent by the network apparatus to the terminal carries a homomorphic key destruction related indication, both the terminal and the network apparatus destroy a corresponding AS-layer or NAS-layer homomorphic key. In an embodiment, if the terminal determines, based on the RRC connection state of the terminal, that the RRC connection is disconnected, the terminal may determine that the life cycle of the homomorphic key ends, and destroy the homomorphic key of the terminal.

For example, FIG. 11 is a schematic flowchart of destroying a homomorphic key according to this application. The procedure may be implemented through interaction between a terminal and a network apparatus, where the network apparatus sends a homomorphic key destruction related indication to the terminal. The procedure includes the following operations.

S801: The network apparatus sends first indication information, where the first indication information indicates to destroy a homomorphic key, and correspondingly, the terminal receives the first indication information.

Destroying the homomorphic key includes destroying a homomorphic encryption key, a homomorphic decryption key, or a homomorphic evaluation key. For example, the terminal receives NAS signaling from the network apparatus, where the NAS signaling carries first indication information that indicates the terminal to destroy a NAS-layer homomorphic key. Alternatively, the terminal receives an RRCRelease message from the network apparatus, where the RRCRelease message carries first indication information that indicates the terminal to destroy an AS-layer homomorphic key.

S802a: The network apparatus destroys the homomorphic key.

S802b: The terminal destroys the homomorphic key.

For example, the network apparatus destroys a NAS-layer or AS-layer homomorphic encryption key/homomorphic decryption key/homomorphic evaluation key, and the terminal destroys a NAS-layer or AS-layer homomorphic encryption key/homomorphic decryption key/homomorphic evaluation key. In an embodiment, when a homomorphic encryption task is completed, even if there is no first indication information, the terminal and the network apparatus destroy the homomorphic evaluation key.

In this application, a user-level homomorphic key (including a homomorphic encryption key and a homomorphic decryption key) is unrelated to a homomorphic encryption task, and is related only to a homomorphic enabled node (for example, a homomorphic encryption party or a homomorphic decryption party). For example, when release of a radio resource control RRC connection of a user is completed, the homomorphic key is destroyed (in other words, the homomorphic key is invalid).

### 5. Update of a Homomorphic Key

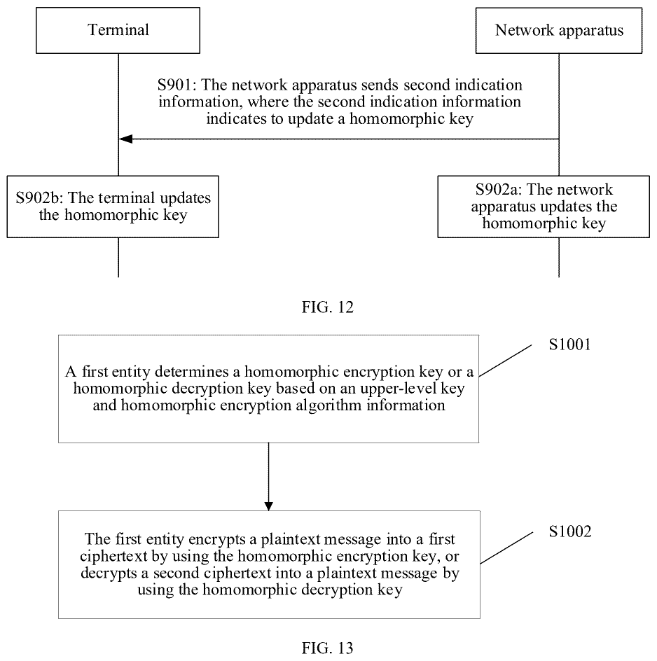

For example, FIG. 12 is a schematic flowchart of updating a homomorphic key according to this application. The procedure may be implemented through interaction between a terminal and a network apparatus, and includes the following operations.

S901: The network apparatus sends second indication information, where the second indication information indicates to update a homomorphic key, and correspondingly, the terminal receives the second indication information.

Updating the homomorphic key includes updating one or more of a homomorphic encryption key, a homomorphic decryption key, and a homomorphic evaluation key. For example, if RRC signaling (for example, RRCReconfiguration) received by the terminal indicates homomorphic key update (for example, HEKeyUpdate), the terminal and the network apparatus re-derive an AS-layer homomorphic encryption key/homomorphic evaluation key/homomorphic decryption key. For another example, if NAS signaling received by the terminal indicates homomorphic key update, the terminal and the network apparatus re-derive a NAS-layer homomorphic encryption key/homomorphic evaluation key/homomorphic decryption key.

S902a: The network apparatus updates the homomorphic key.

S902b: The terminal updates the homomorphic key.

For example, the network apparatus updates a NAS-layer or AS-layer homomorphic encryption key/homomorphic decryption key/homomorphic evaluation key, and the terminal updates a NAS-layer or AS-layer homomorphic encryption key/homomorphic decryption key/homomorphic evaluation key.

IV. Another User-Level Homomorphic Encryption Management Method Provided in this Application

For example, FIG. 13 is a schematic flowchart of another user-level homomorphic encryption management method according to this application. The user-level homomorphic encryption management method may be applied to the communication system shown in FIG. 1 or the network scenario shown in FIG. 7. The user-level homomorphic encryption management method may be performed by a first entity. In an embodiment, the first entity may be a homomorphic encryption management entity (for example, an HECF network element, an HEKM unit, or more generally, a security network element shown in FIG. 1, a terminal, or an access network device). The user-level homomorphic encryption management method includes the following operations.

S1001: The first entity determines a homomorphic encryption key or a homomorphic decryption key based on an upper-level key and homomorphic encryption algorithm information.

S1002: The first entity encrypts a plaintext message into a first ciphertext by using the homomorphic encryption key, or decrypts a second ciphertext obtained through homomorphic evaluation into a plaintext message by using the homomorphic decryption key.

In an embodiment, the first entity derives a homomorphic key based on a USIM symmetric key architecture or a KMC independent key architecture.

The upper-level key includes but is not limited to: an anchor key in the USIM symmetric key architecture, a key derived based on an anchor key, a working key in the KMC independent key architecture, or a key derived based on a working key. For example, if the first entity derives a homomorphic key based on the USIM symmetric key architecture, the upper-level key may be an anchor key derived by a first network element (for example, a network element or an entity having an authentication function, for example, an SEAF) (for example, K_SEAF derived by the SEAF), or a second key derived from an anchor key by a second network element (for example, a network element or an entity having access and mobility management, for example, an AMF) (for example, K_AMF derived by the AMF). For another example, if the first entity derives a homomorphic key based on the KMC independent key architecture, the upper-level key may be a working key (for example, K_work) in the independent key architecture.

The homomorphic encryption algorithm information includes but is not limited to an algorithm identifier, an algorithm type distinguisher, a service network name, a network function type, an identity (for example, a subscription permanent identifier (SUPI)), a non-access stratum count (NAS count), an ABBA parameter, a random number RAND, and the like. In an embodiment, when the first entity derives the homomorphic key based on the USIM symmetric key architecture or the KMC independent key architecture, the homomorphic encryption algorithm information may be different.

For example, when the first entity uses the USIM symmetric key architecture, the upper-level key is K_SEAF, and the homomorphic encryption algorithm information is a first homomorphic algorithm input parameter (including an algorithm type distinguisher, an algorithm identifier, a network function type, an identity, a NAS count, an ABBA parameter, and the like). The first entity may determine a homomorphic encryption key K_NF_HE of an NF based on K_SEAF and the first homomorphic algorithm input parameter. Then, the first entity encrypts a plaintext message into a first ciphertext by using the homomorphic encryption key, or decrypts a second ciphertext obtained through homomorphic evaluation into a plaintext message by using the homomorphic decryption key.

In an embodiment, the first entity may further derive a homomorphic evaluation key. For example, the first entity derives a homomorphic evaluation key based on the USIM symmetric key architecture or the KMC independent key architecture. After S1002, the method further includes the following operations:
the first entity determines a homomorphic evaluation key based on the homomorphic encryption key or the homomorphic decryption key, where the homomorphic evaluation key is used by a homomorphic evaluation party to perform homomorphic evaluation on the first ciphertext, so as to output the second ciphertext; and
the first entity sends the homomorphic evaluation key.

For example, it is assumed that the homomorphic encryption key derived by the first entity is the homomorphic encryption key K_NF_HE of the NF. The first entity may derive corresponding homomorphic evaluation keys K_BSK and K_KSK based on K_NF_HE, and send the corresponding homomorphic evaluation keys K_BSK and K_KSK to the homomorphic evaluation party such as the terminal and/or the access network device.

In an embodiment, the first entity may derive the homomorphic key based on the USIM symmetric key architecture or the KMC independent key architecture (in the symmetric key architecture or the independent key architecture, a related key is derived based on the upper-level key) and the homomorphic encryption algorithm information, thereby implementing a user-level key architecture and management for homomorphic encryption.

V. The following describes in detail derivation of a homomorphic key based on a USIM symmetric key architecture, a KMC independent key architecture, and homomorphic encryption algorithm information.

1. Example 1: A homomorphic encryption key/homomorphic decryption key/homomorphic evaluation key is derived based on a USIM symmetric key architecture and homomorphic encryption algorithm information.

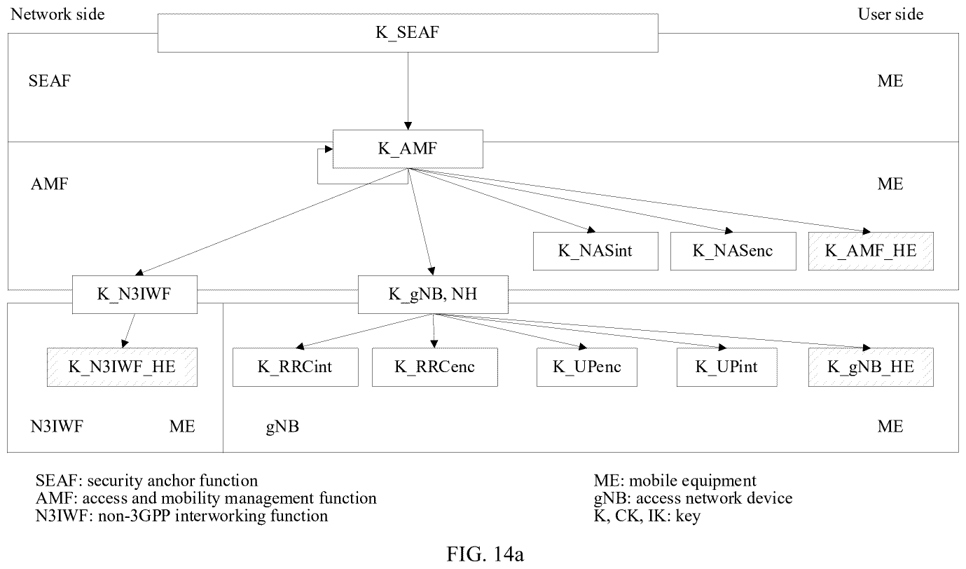

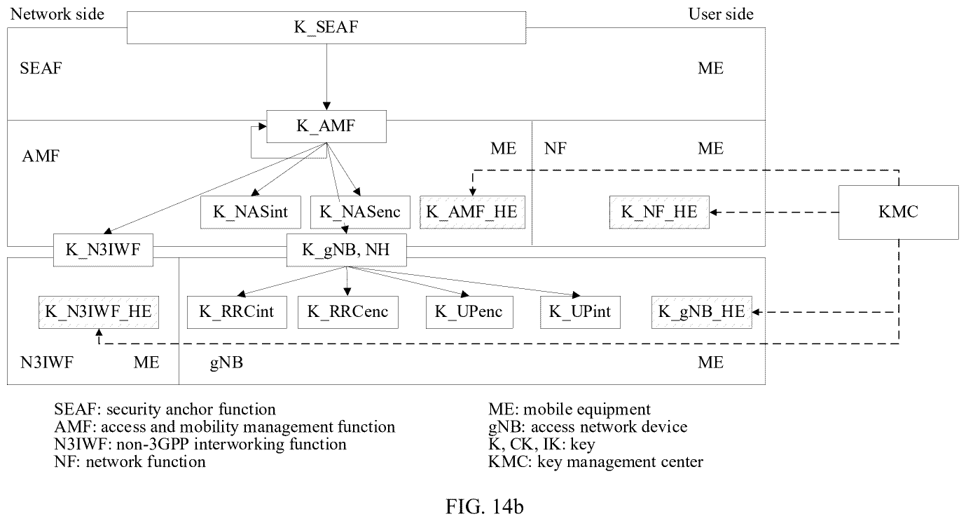

For example, FIG. 14a is a diagram of deriving a homomorphic key based on a USIM symmetric key architecture according to this application. A difference between the USIM symmetric key architecture and the architecture shown in FIG. 2 lies in that homomorphic keys (for example, homomorphic keys re-derived by a first entity, such as K_AMF_HE, K_gNB_HE, and K_N3IWF_HE in shaded blocks in FIG. 14a) are newly added in this application.

a. The first entity (for example, an AMF or another NF) may derive a homomorphic key for a core network or a terminal based on the symmetric key architecture shown in FIG. 14a, where the homomorphic key is used to perform homomorphic encryption, homomorphic decryption, or homomorphic evaluation on data generated in the core network or the terminal.

In an embodiment, the first entity determines a homomorphic encryption key or a homomorphic decryption key of a network function NF network element based on a first key and a first homomorphic algorithm input parameter. The first key is an anchor key derived by a first network element (for example, a network element or an entity having an authentication function). The first homomorphic algorithm input parameter includes one or more of an algorithm type distinguisher, an algorithm identifier, a network function type, a user identity, a non-access stratum NAS count, and an ABBA parameter. For example, a corresponding user-level homomorphic encryption/decryption key K_NF_HE is derived for each NF based on K_SEAF and the first homomorphic algorithm input parameter, and is locally stored in the NF. Then, depending on a homomorphic encryption task, the NF derives homomorphic evaluation keys K_BSK and K_KSK from the homomorphic encryption/decryption key K_NF_HE, and sends the homomorphic evaluation keys K_BSK and K_KSK to homomorphic evaluation nodes such as gNBs/NFs. In an embodiment, the first entity determines a homomorphic encryption key or a homomorphic decryption key of a second network element (for example, a network element or an entity having an access and mobility management function) based on a second key and a second homomorphic algorithm input parameter. The second key is a key derived from an anchor key by the second network element. The second homomorphic algorithm input parameter includes one or more of an algorithm type distinguisher, an algorithm identifier, and a non-access stratum NAS count. For example, the AMF derives a corresponding user-level homomorphic encryption/decryption key K_AMF_HE based on K_AMF and the second homomorphic algorithm input parameter, and stores the corresponding user-level homomorphic encryption/decryption key K_AMF_HE in the AMF. Then, depending on a homomorphic encryption task, the AMF derives homomorphic evaluation keys K_BSK and K_KSK from the homomorphic encryption/decryption key K_AMF_HE, and sends the homomorphic evaluation keys K_BSK and K_KSK to homomorphic evaluation nodes such as gNBs/NFs.

b. The first entity (for example, an access network device) may derive a homomorphic key for an access network based on the symmetric key architecture shown in FIG. 14a, where the homomorphic key is used to perform homomorphic encryption, homomorphic decryption, or homomorphic evaluation on data generated in the access network or a terminal.

In an embodiment, the first entity determines a homomorphic encryption key or a homomorphic decryption key of an access network device based on a third key and a third homomorphic algorithm input parameter. The third key is a key derived again from a second key by a second network element. The third homomorphic algorithm input parameter includes an algorithm type distinguisher and/or an algorithm identifier.

For example, a gNB derives a corresponding user-level homomorphic encryption/decryption key K_gNB_HE based on K_gNB and the third homomorphic algorithm input parameter, and stores the corresponding user-level homomorphic encryption/decryption key K_gNB_HE in the gNB. Then, depending on a homomorphic encryption task, the gNB derives homomorphic evaluation keys K_BSK and K_KSK from the homomorphic encryption/decryption key K_gNB_HE, and sends the homomorphic evaluation keys K_BSK and K_KSK to homomorphic evaluation nodes such as gNBs/UEs. For another example, an N3IWF derives a corresponding user-level homomorphic encryption/decryption key K_N3IWF_HE based on K_N3IWF and the third homomorphic algorithm input parameter, and stores the corresponding user-level homomorphic encryption/decryption key K_N3IWF_HE in the N3IWF. Then, depending on a homomorphic encryption task, the N3IWF derives homomorphic evaluation keys K_BSK and K_KSK from the homomorphic encryption/decryption key K_N3IWF_HE, and sends the homomorphic evaluation keys K_BSK and K_KSK to homomorphic evaluation nodes such as gNBs/UEs.

c. Table of Homomorphic Keys and Homomorphic Encryption Algorithm Information Based on a USIM Symmetric Key Architecture

For example, Table 1 is a table of homomorphic keys and homomorphic encryption algorithm information based on a USIM symmetric key architecture. Table 1 is described by using K_AMF_HE, K_NF_HE, K_gNB_HE, and K_N3IWF_HE as an example. Another homomorphic key not shown is similar.

TABLE 1
Table of homomorphic keys and homomorphic encryption algorithm
information based on a USIM symmetric key architecture

| Homomorphic | Upper- | Homomorphic encryption |
|---|---|---|
| key | level key | algorithm information |
| K_NF_HE | K_SEAF | A first homomorphic algorithm input parameter includes |
| | | one or more of the following: an algorithm type |
| | | distinguisher, an algorithm identifier, a non-access stratum |
| | | count (NAS count), a network function type (NF type), an |
| | | identity (for example, a subscription permanent identifier |
| | | (SUPI), a network access identifier (NAI), an international |
| | | mobile subscriber identity (IMSI), a global cell identity |
| | | (GCI), or a global line identifier (GLI)), and an anti- |
| | | bidding down between architectures parameter (ABBA |
| | | parameter) |
| K_AMF_HE | K_AMF | A second homomorphic algorithm input parameter |
| | | includes one or more of the following: an algorithm type |
| | | distinguisher, an algorithm identifier, and a NAS count |
| K_gNB_HE | K_gNB | A third homomorphic algorithm input parameter includes |
| | | one or more of the following: an algorithm type |
| | | distinguisher and an algorithm identifier |
| K_N3IWF_HE | K_N3IWF | A third homomorphic algorithm input parameter includes |
| | | one or more of the following: an algorithm type |
| | | distinguisher and an algorithm identifier |

The algorithm type distinguisher may include but is not limited to N-NAS-enc-alg, N-NAS-int-alg, N-RRC-enc-alg, N-RRC-int-alg, N-UP-enc-alg, N-UP-int-alg, N-HE-enc-alg, and the like. In an embodiment, the algorithm type distinguisher may be represented by using an index/value. For example, Table 2 is a table of algorithm type distinguishers and values corresponding to the algorithm type distinguishers.

TABLE 2
Table of algorithm type distinguishers and corresponding values

| Algorithm type distinguisher | Value |
|---|---|
| N-NAS-enc-alg | 0x01 |
| N-NAS-int-alg | 0x02 |
| N-RRC-enc-alg | 0x03 |
| N-RRC-int-alg | 0x04 |
| N-UP-enc-alg | 0x05 |
| N-UP-int-alg | 0x06 |
| N-HE-enc-alg | 0x07 |

The algorithm identifier may include but is not limited to: a null ciphering algorithm a SNOW 3G based algorithm, an advanced encryption standard (AES) based algorithm (AES based algorithm), a ZUC based algorithm, a partially homomorphic encryption algorithm (for example, Paillier or ElGamal), an arithmetic-type fully homomorphic encryption algorithm (for example, BGV, BFV, and CKKS), a logical-type fully homomorphic encryption algorithm (for example, TFHE), and the like. In an embodiment, the algorithm identifier may be represented by using an index/value. For example, Table 3 is a table of algorithm identifiers and values corresponding to the algorithm identifiers.

TABLE 3
Table of algorithm identifiers and values
corresponding to the algorithm identifiers

| Algorithm identifier | Value |
|---|---|
| Null ciphering algorithm | 0x00 |
| SNOW 3G based algorithm | 0x01 |
| AES based algorithm | 0x02 |
| ZUC based algorithm | 0x03 |
| Partially homomorphic encryption algorithm | 0x04 |
| Arithmetic-type fully homomorphic encryption algorithm | 0x05 |
| Logical-type fully homomorphic encryption algorithm | 0x06 |

2. Example 2: A homomorphic encryption key/homomorphic decryption key/homomorphic evaluation key is derived based on a KMC independent key architecture and homomorphic encryption algorithm information.

For example, FIG. 14b is a diagram of deriving a homomorphic key based on a KMC independent key architecture according to this application. The difference between the KMC independent key architecture and a USIM symmetric key architecture lies in that a unified key management entity (such as a KMC) generates a homomorphic key, and then the KMC distributes the homomorphic key to each homomorphic party.

a. The KMC may derive a homomorphic key for a core network based on the independent key architecture shown in FIG. 14b, where the homomorphic key is used to perform homomorphic encryption, homomorphic decryption, or homomorphic evaluation on data generated in the core network or a terminal.

In an embodiment, an upper-level key is a working key K_work in an independent key architecture. A first entity determines a homomorphic encryption key or a homomorphic decryption key of a core network element based on the working key in the independent key architecture and a fourth homomorphic algorithm input parameter. The fourth homomorphic algorithm input parameter includes one or more of a random number RAND, a service network name, a network function type, an algorithm type distinguisher, an algorithm identifier, a user identity, and an ABBA parameter.

For example, the KMC derives, based on K_work and the fourth homomorphic algorithm input parameter, a user-level homomorphic encryption/decryption key K_NF_HE corresponding to an NF. The KMC distributes K_NF_HE, and the NF receives K_NF_HE and stores it locally. Then, depending on a homomorphic encryption task, the KMC derives homomorphic evaluation keys K_BSK and K_KSK from the homomorphic encryption/decryption key K_NF_HE, and sends the homomorphic evaluation keys K_BSK and K_KSK to homomorphic evaluation nodes such as gNBs/NFs. For example, the KMC derives, based on K_work and the fourth homomorphic algorithm input parameter, a user-level homomorphic encryption/decryption key K_AMF_HE corresponding to an AMF. The KMC distributes K_AMF_HE, and the AMF receives K_AMF_HE and stores it in the AMF. Then, depending on a homomorphic encryption task, the KMC derives homomorphic evaluation keys K_BSK and K_KSK from the homomorphic encryption/decryption key K_AMF_HE, and sends the homomorphic evaluation keys K_BSK and K_KSK to homomorphic evaluation nodes such as gNBs/NFs.

b. The KMC may derive a homomorphic key for an access network based on the independent key architecture shown in FIG. 14b, where the homomorphic key is used to perform homomorphic encryption, homomorphic decryption, or homomorphic evaluation on data generated in the access network or a terminal.

In an embodiment, an upper-level key is a working key K_work in an independent key architecture. A first entity determines a homomorphic encryption key and a homomorphic decryption key of an access network device based on the working key in the independent key architecture and a fifth homomorphic algorithm input parameter. The fifth homomorphic algorithm input parameter includes one or more of a random number RAND, a service network name, a network function type, an algorithm type distinguisher, an algorithm identifier, a user identity, an ABBA parameter, a non-access stratum NAS count, and an access type.

For example, the KMC derives, based on K_work and the fifth homomorphic algorithm input parameter, a user-level homomorphic encryption/decryption key K_gNB_HE corresponding to a gNB, and stores the user-level homomorphic encryption/decryption key K_gNB_HE in the gNB. Then, depending on a homomorphic encryption task, the gNB derives homomorphic evaluation keys K_BSK and K_KSK from the homomorphic encryption/decryption key K_gNB_HE, and sends the homomorphic evaluation keys K_BSK and K_KSK to homomorphic evaluation nodes such as gNBs/UEs. For another example, an N3IWF derives a corresponding user-level homomorphic encryption/decryption key K_N3IWF_HE based on K_work and the fifth homomorphic algorithm input parameter. The KMC distributes K_N3IWF_HE, and an AMF receives K_N3IWF_HE and stores it in the N3IWF. Then, depending on a homomorphic encryption task, the KMC derives homomorphic evaluation keys K_BSK and K_KSK from the homomorphic encryption/decryption key K_N3IWF_HE, and sends the homomorphic evaluation keys K_BSK and K_KSK to homomorphic evaluation nodes such as gNBs/UEs.

c. Table of Homomorphic Keys and Homomorphic Encryption Algorithm Information Based on a KMC Independent Key Architecture

For example, Table 4 is a table of homomorphic keys and homomorphic encryption algorithm information based on a KMC independent key architecture. Table 4 is described by using K_AMF_HE, K_NF_HE, K_gNB_HE, and K_N3IWF_HE as an example. Another homomorphic key not shown is similar.

TABLE 4
Table of homomorphic keys and homomorphic encryption algorithm
information based on a KMC independent key architecture

| Homomorphic | Upper-level | |
|---|---|---|
| key | key | Homomorphic encryption algorithm information |
| K_NF_HE | KMC | Fourth homomorphic algorithm input parameter: a RAND, a |
| | working key | service network name, an algorithm type distinguisher, an |
| | K_work | algorithm identifier, an NF type, an identity (for example, an |
| | | SUPI/an NAI (an IMSI, an NAI, a GCI, a GLI, or the like)), |
| | | and an ABBA parameter |
| K_AMF_HE | K_work | Fourth homomorphic algorithm input parameter: a RAND, a |
| | | service network name, an algorithm type distinguisher, an |
| | | algorithm identifier, an NF type, an identity (for example, an |
| | | SUPI/an NAI (an IMSI, an NAI, a GCI, a GLI, or the like)), |
| | | and an ABBA parameter |
| K_gNB_HE | K_work | Fifth homomorphic algorithm input parameter: a RAND, a |
| | | service network name, an algorithm type distinguisher, an |
| | | algorithm identifier, an NF type, an identity (for example, an |
| | | SUPI/an NAI (an IMSI, an NAI, a GCI, a GLI, or the like)), |
| | | an ABBA parameter, a NAS count, and an access type |
| | | distinguisher (access type distinguisher) |
| K_N3IWF_HE | K_work | Fifth homomorphic algorithm input parameter: a RAND, a |
| | | service network name, an algorithm type distinguisher, an |
| | | algorithm identifier, an NF type, an identity (for example, an |
| | | SUPI/an NAI (an IMSI, an NAI, a GCI, a GLI, or the like)), |
| | | an ABBA parameter, a NAS count, and an access type |
| | | distinguisher |

For examples of the algorithm type distinguisher and the algorithm identifier, refer to corresponding descriptions in Example 1. Details are not described herein again.

3. A symmetric or asymmetric user-level homomorphic encryption/decryption key can be derived based on a USIM symmetric key architecture and a KMC independent key architecture.

The USIM symmetric key architecture is used as an example. It is assumed that an AMF derives a symmetric homomorphic encryption/decryption key based on the USIM symmetric key architecture. In this case, the AMF derives a homomorphic key K_AMF_HE based on K_AMF, and uses K_AMF_HE as a symmetric homomorphic encryption key and a homomorphic decryption key. In an embodiment, depending on a homomorphic encryption task, the AMF derives homomorphic evaluation keys K_BSK and K_KSK based on K_AMF_HE. For another example, it is assumed that the AMF derives an asymmetric homomorphic encryption/decryption key based on the USIM symmetric key architecture. In this case, the AMF derives a homomorphic key K_AMF_HE based on K_AMF, and uses K_AMF_HE as an asymmetric private key, where the private key is used as a homomorphic decryption key. Then, the AMF continues to derive a public key K_AMF_HE_EN based on the homomorphic decryption key, where the public key is used as a homomorphic encryption key. In an embodiment, depending on a homomorphic encryption task, the AMF derives homomorphic evaluation keys K_BSK and K_KSK based on an asymmetric homomorphic encryption key K_AMF_HE_EN and a homomorphic decryption key K_AMF_HE.

It may be understood that a processing method for deriving a symmetric or asymmetric user-level homomorphic encryption/decryption key based on the KMC independent key architecture is similar to the foregoing examples. Details are not described herein again.

VI. In a homomorphic encryption network scenario, a plurality of homomorphic encryption parties use different homomorphic encryption keys, a plurality of homomorphic evaluation parties use different homomorphic evaluation keys, and a plurality of homomorphic decryption parties use different homomorphic decryption keys.

For example, for a homomorphic encryption task, the following scenario is assumed in an embodiment: A homomorphic encryption party is a terminal side (for example, including a plurality of terminals, UE_1, UE_2, . . . , and UE_K), and homomorphic encryption keys of the plurality of homomorphic encryption parties are different. A homomorphic decryption party is a network side (for example, including K homomorphic decryption parties, which may be a CN/an APP, and the like). Homomorphic decryption keys of the K homomorphic decryption parties are different (it is assumed that the homomorphic decryption keys are K temporary homomorphic decryption keys). That is, no single network element/entity holds all homomorphic decryption keys. A homomorphic evaluation party is a network side (for example, including a plurality of devices or entities, which may be a base station gNB, a road side unit RSU, a network element NF, and the like).

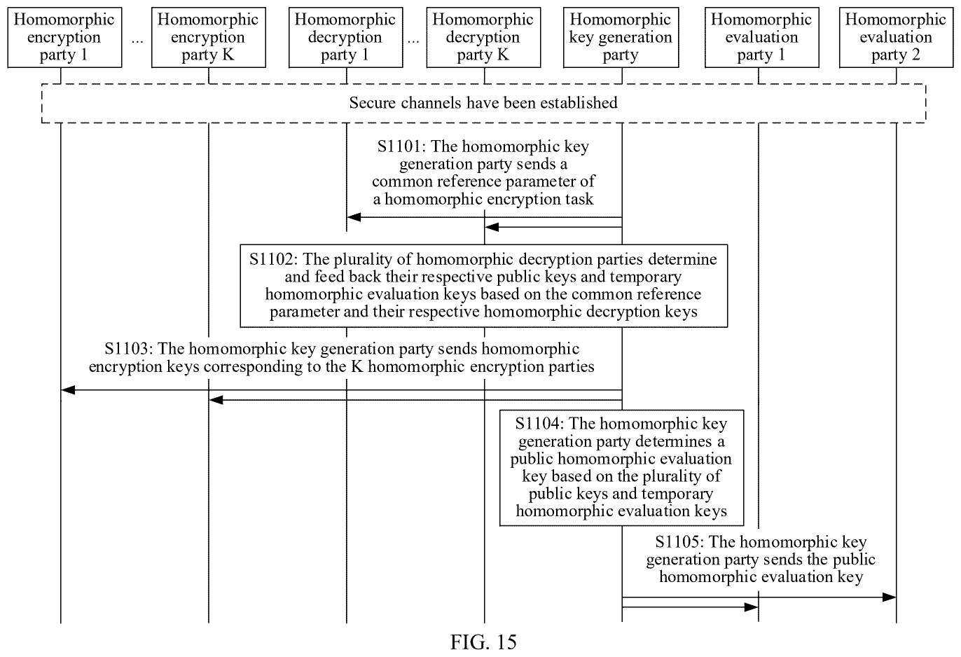

Because no single network element/entity holds all homomorphic decryption keys, an embodiment is an interactive homomorphic key generation procedure. For example, FIG. 15 is a diagram of an interactive homomorphic key generation procedure according to this application. The procedure is implemented through interaction among a homomorphic key generation party (for example, an HEKM unit), a plurality of homomorphic encryption parties (for example, a homomorphic encryption party 1 to a homomorphic encryption party K), a plurality of homomorphic decryption parties (for example, a homomorphic decryption party 1 to a homomorphic decryption party K), and a plurality of homomorphic evaluation parties (for example, a homomorphic evaluation party 1 and a homomorphic evaluation party 2), and includes the following operations.

S1101: The homomorphic key generation party sends a common reference parameter for a homomorphic encryption task, and correspondingly, the K homomorphic encryption parties receive the common reference parameter for the homomorphic encryption task. The common reference parameter is used to derive a homomorphic decryption key/a homomorphic evaluation key.

A set of integers is represented as [symbol] , and

$${ℤ}_{q}^{n}$$

represents a set of integers whose ciphertext modulus is q and dimension is n. For ease of description, a superscript or a subscript of the set of integers may be omitted. For example, the set of integers may be represented as

$${Z}_{q} {=}^{Δ} ( - q / 2 , q / 2 ] ⋂ Z \cdot {R}_{q}^{2}$$

represents a polynomial ring whose ciphertext modulus is q and dimension is 2, where the subscript indicates that the ciphertext modulus is q, and the superscript indicates that the dimension is 2. Z represents a set of positive integers.

For example, the homomorphic key generation party derives a plurality of homomorphic decryption keys based on a key generation parameter of the homomorphic encryption task. For example, any homomorphic decryption key K_{dec}

$${K}_{dec} = ( 1 , {s}_{i} ) ∈ {R}_{q}^{2} ,$$

where sᵢ∈

$${ℤ}_{q}^{n}$$

is a randomly generated homomorphic decryption key component in a fully homomorphic encryption algorithm, and 1≤i≤N.

The homomorphic key generation party selects the common reference parameter. For example, a first random polynomial vector a∈

$${R}_{q}^{d}$$

and a gadget decomposition vector g∈Z^{d} are selected as the common reference parameter, where d represents a gadget dimension.

In an embodiment, before S1101, secure channels have been established among the homomorphic key generation party, the plurality of homomorphic encryption parties, the plurality of homomorphic decryption parties, and the plurality of homomorphic evaluation parties.

S1102: The plurality of homomorphic decryption parties determine and feed back their respective public keys and temporary homomorphic evaluation keys based on the common reference parameter and their respective homomorphic decryption keys.

In an embodiment, the homomorphic key generation party sends a corresponding homomorphic decryption key to each of the plurality of homomorphic decryption parties.

In an embodiment, the K homomorphic decryption parties independently derive a plurality of homomorphic decryption keys that are securely stored locally.

For example, any homomorphic decryption party i generates a corresponding public key bᵢ based on the common reference parameter and a homomorphic decryption key sᵢ of the homomorphic decryption party i, and sends the public key bᵢ to the homomorphic key generation party, where bᵢ=(−a·sᵢ+eᵢ)∈

$${R}_{q}^{d} ,$$

and eᵢ represents noise.

For another example, any homomorphic decryption party i generates a corresponding temporary homomorphic evaluation key Dᵢ based on the common reference parameter and a homomorphic decryption key sᵢ of the homomorphic decryption party i, and sends the temporary homomorphic evaluation key Dᵢ to the homomorphic key generation party. For example, Dᵢ may include three parts, and is represented as

$${D}_{i} = [ {d}_{i , 0} \vert {d}_{i , 1} \vert {d}_{i , 2} ] ∈ {R}_{q}^{d \times 3} \cdot {d}_{i , 1}$$

is determined based on

$${R}_{q}^{d} ,$$

and may be represented as

$${d}_{i , 1} ← U ( {R}_{q}^{d} ) ,$$

where the arrow represents sampling a number from the set U( ), and U( ) is a uniformly distributed set over the polynomial ring

$${R}_{q}^{2} .$$

d_{i,0} is determined based on a homomorphic decryption key component sᵢ, a common reference parameter g, a polynomial ring sample rᵢ drawn from a random distribution, and random noise eᵢ₁, and may be represented as d_{i,0}=−sᵢ·d_{i,1}+rᵢ·g+eᵢ₁ ∈

$${R}_{q}^{d} .$$

d_{i,2} is determined based on a polynomial ring sample rᵢ drawn from a random distribution, a first random polynomial vector a, a homomorphic decryption key component sᵢ, a common reference parameter g, and random noise eᵢ₂, and may be represented as

$${d}_{i , 2} = {r}_{i} \cdot a + {s}_{i} \cdot g + {e}_{i 2} ∈ {R}_{q}^{d} .$$

S1103: The homomorphic key generation party sends homomorphic encryption keys corresponding to the K homomorphic encryption parties, and correspondingly, the K homomorphic encryption parties receive the corresponding homomorphic encryption keys.

For example, the homomorphic key generation party uses a derived public key b, as a homomorphic encryption key of each homomorphic encryption party, and sends the corresponding homomorphic encryption key to each homomorphic encryption party.

In an embodiment, the plurality of homomorphic encryption parties may perform homomorphic encryption on a plaintext message based on their respective homomorphic encryption keys.

S1104: The homomorphic key generation party determines a public homomorphic evaluation key based on the plurality of public keys and temporary homomorphic evaluation keys.

For example, a KSK algorithm is used as an example. A public homomorphic evaluation key derived by the homomorphic key generation party is formed by a matrix with K rows and K columns, where K is a quantity of homomorphic encryption keys. Each element K_{i,j} of the public homomorphic evaluation key includes three parts: [k_{i,j,0}|k_{i,j,1}|k_{i,j,2}]. The first two parts [k_{i,j,0}|k_{i,j,1}] of the element of the public homomorphic evaluation key are obtained by multiplying the first two components [d_{i,0}|d_{i,1}] of the temporary homomorphic evaluation key by a gadget component of a public key bᵢ. The third part k_{i,j,2} of the element of the public homomorphic evaluation key is equal to the third component d_{i,2} of the temporary homomorphic evaluation key. The public homomorphic evaluation key may be represented as r̅l̅k̅={K_{i,j}}_{1≤i,j≤k′} where

$${K}_{i , j} = [ {k}_{i , j , 0} \vert {k}_{i , j , 1} \vert {k}_{i , j , 2} ] ∈ {R}_{q}^{d \times 3} , [ {k}_{i , j , 0} \vert {k}_{i , j , 1} ] = [ \begin{matrix}\underline{{g}^{- 1} ( {b}_{j} [ 1 ] )} \\ ⋮ \\ \overline{{g}^{- 1} ( {b}_{j} [ d ] )}\end{matrix} ] \cdot [ {d}_{i , 0} \vert {d}_{i , 1} ] , \\ and {k}_{i , j , 2} = {d}_{i , 2} .$$

S1105: The homomorphic key generation party sends the public homomorphic evaluation key, and correspondingly, the plurality of homomorphic evaluation parties receive the public homomorphic evaluation key.

For example, the HEKM unit sends a public homomorphic evaluation key to both a homomorphic evaluation party 1 and a homomorphic evaluation party 2.

In an embodiment, after receiving the public homomorphic evaluation key, the homomorphic evaluation party may perform homomorphic evaluation by using the public homomorphic evaluation key.

In an embodiment, in a same homomorphic encryption task, although no single network element/entity holds all homomorphic decryption keys, ciphertext data can be reused through interaction among a homomorphic key generation party, a homomorphic encryption party, a homomorphic evaluation party, and a homomorphic decryption party, so that user-level homomorphic encryption data can be transferred and undergo homomorphic evaluation in different homomorphic encryption tasks.

To implement functions in the method provided in this application, the apparatus or the device provided in this application may include a hardware structure and/or a software module, to implement the foregoing functions in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions. In this application, module division is an example, and is merely logic function division. In an embodiment, another division manner may be used. In addition, functional modules in embodiments of this application may be integrated into one processor, or may exist alone physically, or two or more modules may be integrated into one module. The integrated module may be implemented in a form of hardware, or may be implemented in a form of a software functional module.

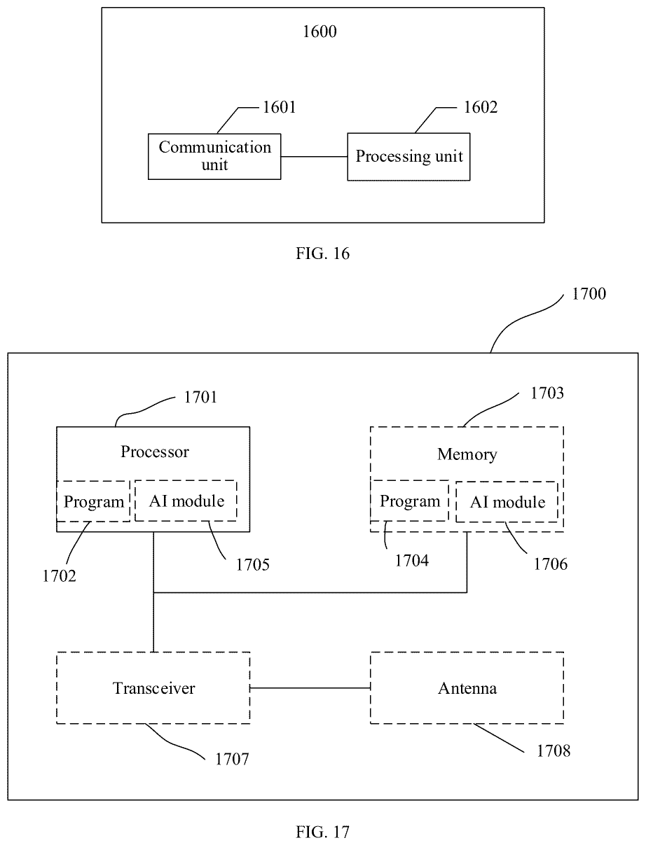

FIG. 16 is a diagram of a communication apparatus according to this application. The apparatus may include a module in one-to-one correspondence with the method/operation/step/action described in any one of the embodiments shown in FIG. 6a to FIG. 15. The module may be a hardware circuit, or may be software, or may be implemented by a hardware circuit in combination with software.

The apparatus 1600 includes a communication unit 1601 and a processing unit 1602, configured to implement the method performed by each device in the foregoing embodiments.

In an embodiment, the apparatus is a terminal, or is located in a terminal. In an embodiment, the communication unit 1601 is configured to receive a homomorphic security capability of a network side. The processing unit 1602 is configured to determine a homomorphic encryption algorithm based on a homomorphic security capability of the terminal and the homomorphic security capability of the network side. The communication unit 1601 is further configured to send an identifier of the homomorphic encryption algorithm.

For execution procedures of the communication unit 1601 and the processing unit 1602 in this implementation, refer to descriptions of the operations performed by the terminal in the foregoing method embodiments and corresponding descriptions in the summary. Details are not described herein again. In the communication method implemented by the apparatus, the terminal may receive the homomorphic security capability of the network side, so as to determine the homomorphic encryption algorithm by comprehensively considering homomorphic security capabilities of a terminal side and the network side. This helps the terminal provide user-level high privacy protection strength. In addition, the homomorphic encryption algorithm is determined by comprehensively considering the homomorphic security capabilities of the terminal side and the network side. Therefore, this helps improve reusability of a homomorphic key, and helps ciphertext data generated based on the homomorphic key be transferred and undergo homomorphic evaluation in different homomorphic encryption tasks.

In an embodiment, the apparatus is a terminal, or is located in a terminal. In an embodiment, the communication unit 1601 is configured to send a homomorphic security capability of the terminal. The communication unit 1601 is further configured to receive an identifier of a homomorphic encryption algorithm, where the homomorphic encryption algorithm is determined by a network apparatus based on the homomorphic security capability of the terminal and a homomorphic security capability of a network side.

For execution procedures of the communication unit 1601 and the processing unit 1602 in an embodiment, refer to descriptions of the operations performed by the terminal in the foregoing method embodiments and corresponding descriptions in the summary. Details are not described herein again. In the communication method implemented by the apparatus, the terminal may send the homomorphic security capability of the terminal to the network apparatus, and the network apparatus determines the homomorphic encryption algorithm by comprehensively considering homomorphic security capabilities of a terminal side and the network side, and feeds back the homomorphic encryption algorithm to the terminal. This helps the terminal provide user-level high privacy protection strength. In addition, the homomorphic encryption algorithm is determined by comprehensively considering the homomorphic security capabilities of the terminal side and the network side. Therefore, this helps improve reusability of a homomorphic key, and helps ciphertext data generated based on the homomorphic key be transferred and undergo homomorphic evaluation in different homomorphic encryption tasks.

In an embodiment, the apparatus is a first entity (an access network device or a network entity (for example, a core network element or a function network element)), or is located in a first entity. In an embodiment, the communication unit 1601 is configured to send a homomorphic security capability of a network side. The communication unit 1601 is further configured to receive an identifier of a homomorphic encryption algorithm, where the homomorphic encryption algorithm is determined by a terminal based on a homomorphic security capability of the terminal and the homomorphic security capability of the network side.

For execution procedures of the communication unit 1601 and the processing unit 1602 in an embodiment, refer to descriptions of the operations performed by the first entity in the foregoing method embodiments and corresponding descriptions in the summary. Details are not described herein again. In the communication method implemented by the apparatus, the first entity may send a homomorphic security capability of the first entity to the terminal, and the terminal determines the homomorphic encryption algorithm by comprehensively considering homomorphic security capabilities of a terminal side and the network side, and feeds back the homomorphic encryption algorithm to the first entity. This helps the network side provide user-level high privacy protection strength. In addition, the homomorphic encryption algorithm is determined by comprehensively considering the homomorphic security capabilities of the terminal side and the network side. Therefore, this helps improve reusability of a homomorphic key, and helps ciphertext data generated based on the homomorphic key be transferred and undergo homomorphic evaluation in different homomorphic encryption tasks.

In an embodiment, the apparatus is a first entity (an access network device or a network entity (for example, a core network element or a function network element)), or is located in a first entity. In an embodiment, the communication unit 1601 is configured to receive a homomorphic security capability of a terminal. The processing unit 1602 is configured to determine a homomorphic encryption algorithm based on the homomorphic security capability of the terminal and a homomorphic security capability of a network side. The communication unit 1601 is further configured to send an identifier of the homomorphic encryption algorithm.

For execution procedures of the communication unit 1601 and the processing unit 1602 in an embodiment, refer to descriptions of the operations performed by the first entity in the foregoing method embodiments and corresponding descriptions in the summary. Details are not described herein again. In the communication method implemented by the apparatus, the first entity may receive the homomorphic security capability of the terminal, so as to determine the homomorphic encryption algorithm by comprehensively considering homomorphic security capabilities of a terminal side and the network side. This helps the first entity provide user-level high privacy protection strength. In addition, the homomorphic encryption algorithm is determined by comprehensively considering the homomorphic security capabilities of the terminal side and the network side. Therefore, this helps improve reusability of a homomorphic key, and helps ciphertext data generated based on the homomorphic key be transferred and undergo homomorphic evaluation in different homomorphic encryption tasks.

In an embodiment, the apparatus is a first entity (an access network device or a network entity (for example, a core network element or a function network element)), or is located in a first entity. In an embodiment, the processing unit 1602 is configured to determine a homomorphic encryption key or a homomorphic decryption key based on an upper-level key and homomorphic encryption algorithm information. The processing unit 1602 is further configured to encrypt a plaintext message into a first ciphertext by using the homomorphic encryption key, or decrypt a second ciphertext into a plaintext message by using the homomorphic decryption key.

For execution procedures of the communication unit 1601 and the processing unit 1602 in an embodiment, refer to descriptions of the operations performed by the first entity in the foregoing method embodiments and corresponding descriptions in the summary. Details are not described herein again. In the communication method implemented by the apparatus, a user-level key architecture and a management scheme for homomorphic encryption are designed to adapt to a key architecture and management of an existing cellular network. For example, the first entity may derive a homomorphic key based on a USIM symmetric key architecture or a KMC independent key architecture (in the symmetric key architecture or the independent key architecture, a related key is derived based on an upper-level key) and homomorphic encryption algorithm information, thereby implementing a user-level key architecture and management for homomorphic encryption.

FIG. 17 is a diagram of another communication apparatus according to this application. The communication apparatus is configured to implement the communication method in the foregoing method embodiments. It may be understood that the communication apparatus 1700 includes necessary forms, such as modules, units, elements, circuits, or interfaces, and the necessary forms are appropriately configured together to perform the method in this application. For example, the communication apparatus 1700 may be a functional entity such as an enabling server, an enabling client, a transmission server, or an application server, or may be a component (for example, a chip) in a functional entity, and is configured to implement the method described in the foregoing method embodiments. The communication apparatus 1700 includes one or more processors 1701. The processor 1701 may be a general-purpose processor, a dedicated processor, or the like. For example, the processor may be a baseband processor or a central processing unit. The baseband processor may be configured to process a communication protocol and communication data. The central processing unit may be configured to control the communication apparatus, execute a software program, and process data of the software program.

In an embodiment, the processor 1701 may include a program 1702 (which may also be referred to as code or instructions sometimes). The program 1702 may be run on the processor 1701, so that the communication apparatus 1700 performs the method described in the foregoing embodiments. In another possible design, the communication apparatus 1700 includes a circuit (not shown in FIG. 17). The circuit is configured to implement a function of a functional entity such as an enabling server, an enabling client, a transmission server, and an application server in the foregoing embodiments.

In an embodiment, the communication apparatus 1700 may include one or more memories 1703, and the memory 1703 stores a program 1704 (which may also be referred to as code or instructions sometimes). The program 1704 may be run on the processor 1701, so that the communication apparatus 1700 performs the method described in the foregoing method embodiments.

In an embodiment, the processor 1701 and/or the memory 1703 may include AI modules 1705 and 1706. The AI module is configured to implement an AI-related function. The AI module may be implemented by using software, hardware, or a combination of the software and the hardware. For example, the AI module may include an RIC module. For example, the AI module may be a near-real-time RIC or a non-real-time RIC.

In an embodiment, the communication apparatus 1700 further includes a transceiver 1707 and an antenna 1708. The transceiver 1707 and the antenna 1708 can implement a receiving and sending function, for example, communicate with another device through a transmission medium, so that the communication apparatus 1700 can communicate with the another device.

In an embodiment, the apparatus is a terminal, or is located in a terminal. In an embodiment, the transceiver 1707 and the antenna 1708 are configured to receive a homomorphic security capability of a network side. The processor 1701 is configured to determine a homomorphic encryption algorithm based on a homomorphic security capability of the terminal and the homomorphic security capability of the network side. The transceiver 1707 and the antenna 1708 are configured to send an identifier of the homomorphic encryption algorithm.

For execution procedures of the communication apparatus 1700 in an embodiment, refer to descriptions of the operations performed by the terminal in the foregoing method embodiments and corresponding descriptions in the summary. Details are not described herein again. In the communication method implemented by the apparatus, the terminal may receive the homomorphic security capability of the network side, so as to determine the homomorphic encryption algorithm by comprehensively considering homomorphic security capabilities of a terminal side and the network side. This helps the terminal provide user-level high privacy protection strength. In addition, the homomorphic encryption algorithm is determined by comprehensively considering the homomorphic security capabilities of the terminal side and the network side. Therefore, this helps improve reusability of a homomorphic key, and helps ciphertext data generated based on the homomorphic key be transferred and undergo homomorphic evaluation in different homomorphic encryption tasks.

In an embodiment, the apparatus is a terminal, or is located in a terminal. In an embodiment, the transceiver 1707 and the antenna 1708 are configured to send a homomorphic security capability of the terminal. The transceiver 1707 and the antenna 1708 are further configured to receive an identifier of a homomorphic encryption algorithm, where the homomorphic encryption algorithm is determined by a network apparatus based on the homomorphic security capability of the terminal and a homomorphic security capability of a network side.

For execution procedures of the communication apparatus 1700 in an embodiment, refer to descriptions of the operations performed by the terminal in the foregoing method embodiments and corresponding descriptions in the summary. Details are not described herein again. In the communication method implemented by the apparatus, the terminal may send the homomorphic security capability of the terminal to the network apparatus, and the network apparatus determines the homomorphic encryption algorithm by comprehensively considering homomorphic security capabilities of a terminal side and the network side, and feeds back the homomorphic encryption algorithm to the terminal. This helps the terminal provide user-level high privacy protection strength. In addition, the homomorphic encryption algorithm is determined by comprehensively considering the homomorphic security capabilities of the terminal side and the network side. Therefore, this helps improve reusability of a homomorphic key, and helps ciphertext data generated based on the homomorphic key be transferred and undergo homomorphic evaluation in different homomorphic encryption tasks.

In an embodiment, the apparatus is a first entity (an access network device or a network entity (for example, a core network element or a function network element)), or is located in a first entity. In an embodiment, the transceiver 1707 and the antenna 1708 are configured to send a homomorphic security capability of a network side. The transceiver 1707 and the antenna 1708 are further configured to receive an identifier of a homomorphic encryption algorithm, where the homomorphic encryption algorithm is determined by a terminal based on a homomorphic security capability of the terminal and the homomorphic security capability of the network side.

For execution procedures of the communication apparatus 1700 in an embodiment, refer to descriptions of the operations performed by the first entity in the foregoing method embodiments and corresponding descriptions in the summary. Details are not described herein again. In the communication method implemented by the apparatus, the first entity may send a homomorphic security capability of the first entity to the terminal, and the terminal determines the homomorphic encryption algorithm by comprehensively considering homomorphic security capabilities of a terminal side and the network side, and feeds back the homomorphic encryption algorithm to the first entity. This helps the network side provide user-level high privacy protection strength. In addition, the homomorphic encryption algorithm is determined by comprehensively considering the homomorphic security capabilities of the terminal side and the network side. Therefore, this helps improve reusability of a homomorphic key, and helps ciphertext data generated based on the homomorphic key be transferred and undergo homomorphic evaluation in different homomorphic encryption tasks.

In an embodiment, the apparatus is a first entity (an access network device or a network entity (for example, a core network element or a function network element)), or is located in a first entity. In an embodiment, the transceiver 1707 and the antenna 1708 are configured to receive a homomorphic security capability of a terminal. The processor 1701 is configured to determine a homomorphic encryption algorithm based on the homomorphic security capability of the terminal and a homomorphic security capability of a network side. The transceiver 1707 and the antenna 1708 are further configured to send an identifier of the homomorphic encryption algorithm.

For execution procedures of the communication apparatus 1700 in an embodiment, refer to descriptions of the operations performed by the first entity in the foregoing method embodiments and corresponding descriptions in the summary. Details are not described herein again. In the communication method implemented by the apparatus, the first entity may receive the homomorphic security capability of the terminal, so as to determine the homomorphic encryption algorithm by comprehensively considering homomorphic security capabilities of a terminal side and the network side. This helps the first entity provide user-level high privacy protection strength. In addition, the homomorphic encryption algorithm is determined by comprehensively considering the homomorphic security capabilities of the terminal side and the network side. Therefore, this helps improve reusability of a homomorphic key, and helps ciphertext data generated based on the homomorphic key be transferred and undergo homomorphic evaluation in different homomorphic encryption tasks.

In an embodiment, the apparatus is a first entity (an access network device or a network entity (for example, a core network element or a function network element)), or is located in a first entity. In an embodiment, the processor 1701 is configured to determine a homomorphic encryption key or a homomorphic decryption key based on an upper-level key and homomorphic encryption algorithm information. The processor 1701 is further configured to encrypt a plaintext message into a first ciphertext by using the homomorphic encryption key, or decrypt a second ciphertext into a plaintext message by using the homomorphic decryption key.

For execution procedures of the communication apparatus 1700 in an embodiment, refer to descriptions of the operations performed by the first entity in the foregoing method embodiments and corresponding descriptions in the summary. Details are not described herein again. In the communication method implemented by the apparatus, a user-level key architecture and a management scheme for homomorphic encryption are designed to adapt to a key architecture and management of an existing cellular network. For example, the first entity may derive a homomorphic key based on a USIM symmetric key architecture or a KMC independent key architecture (in the symmetric key architecture or the independent key architecture, a related key is derived based on an upper-level key) and homomorphic encryption algorithm information, thereby implementing a user-level key architecture and management for homomorphic encryption. In this application, the processor may be a general-purpose processor, a digital signal processor, an application-specific integrated circuit, a field programmable gate array or another programmable logic device, a discrete gate or a transistor logic device, or a discrete hardware component, and may implement or perform the methods, operations, and logical block diagrams that are disclosed in this application. The general-purpose processor may be a microprocessor, any conventional processor, or the like. The operations of the method disclosed with reference to this application may be directly performed by a hardware processor, or may be performed by using a combination of hardware in the processor and a software module.

In this application, the memory may be a non-volatile memory, for example, a hard disk drive (HDD) or a solid-state drive (SSD), or may be a volatile memory, for example, a random-access memory (RAM). The memory is any other medium that can be used to carry or store expected program code in a form of an instruction or a data structure and that can be accessed by a computer, but is not limited thereto. The memory in this application may alternatively be a circuit or any other apparatus that can implement a storage function, and is configured to store program instructions and/or data.

This application provides another communication apparatus, including a processor and an interface. In an embodiment, the apparatus further includes a memory. The processor is coupled to the memory. The processor is configured to read and execute computer instructions stored in the memory, to implement the communication method in the embodiments shown in FIG. 6a to FIG. 15.

This application provides a communication system. The communication system includes one or more of the entities or the devices in the embodiments shown in FIG. 6a to FIG. 15.

This application provides a computer-readable storage medium. The computer-readable storage medium stores a program or instructions. When the program or the instructions are run on a computer, the computer is enabled to perform the communication method in the embodiments shown in FIG. 6a to FIG. 15.

This application provides a computer program product. The computer program product includes instructions. When the instructions are run on a computer, the computer is enabled to perform the communication method in the embodiments shown in FIG. 6a to FIG. 15.

This application provides a chip or a chip system. The chip or the chip system includes at least one processor and an interface. The interface and the at least one processor are interconnected through a line. The at least one processor is configured to run a computer program or instructions, to perform the communication method in the embodiments shown in FIG. 6a to FIG. 15.

The interface in the chip may be an input/output interface, a pin, a circuit, or the like.

The chip system may be a system on chip (SoC), a baseband chip, or the like. The baseband chip may include a processor, a channel encoder, a digital signal processor, a modem, an interface module, and the like.

In an embodiment, the chip or the chip system described in this application further includes at least one memory, and the at least one memory stores instructions. The memory may be a storage unit inside the chip, for example, a register or a cache, or may be a storage unit (for example, a read-only memory or a random access memory) of the chip.

All or some of the technical solutions provided in this application may be implemented by using software, hardware, firmware, or any combination thereof. When software is used to implement the technical solutions, all or some of the technical solutions may be implemented in a form of a computer program product. The computer program product includes one or more computer instructions. When the computer program instructions are loaded and executed on the computer, the procedure or functions according to this application are all or partially generated. The computer may be a general-purpose computer, a dedicated computer, a computer network, a network device, a terminal, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk drive, or a magnetic tape), an optical medium (for example, a digital video disc (DVD)), a semiconductor medium, or the like.

In this application, without a logical contradiction, mutual reference can be made between embodiments. For example, mutual reference can be made between methods and/or terms in method embodiments, mutual reference can be made between functions and/or terms in apparatus embodiments, and mutual reference can be made between functions and/or terms in the apparatus embodiments and the method embodiments.

It is clear that one of ordinary skilled in the art can make various modifications and variations to this application without departing from the scope of this application. This application is intended to cover these modifications and variations of this application provided that they fall within the scope of protection defined by the following claims of this application and their equivalent technologies.

What is claimed is:

1. A user-level homomorphic encryption management method, comprising:
receiving a homomorphic security capability of a network side;
determining a homomorphic encryption algorithm based on a homomorphic security capability of a terminal and the homomorphic security capability of the network side; and
sending an identifier of the homomorphic encryption algorithm.

2. The method according to claim 1, wherein the homomorphic security capability of the network side is carried in a security mode command, and the homomorphic encryption algorithm is carried in a security mode complete message.

3. The method according to claim 1, wherein the method further comprises:
determining a homomorphic encryption key and/or a homomorphic decryption key based on the homomorphic encryption algorithm, wherein the homomorphic encryption key is used to encrypt a plaintext message into a first ciphertext, and the homomorphic decryption key is used to decrypt a second ciphertext into a plaintext message.

4. The method according to claim 1, wherein the method further comprises:
receiving a homomorphic evaluation key after a homomorphic encryption task is created, wherein the homomorphic evaluation key is used by one or more homomorphic evaluation parties in the homomorphic encryption task to perform homomorphic evaluation on a first ciphertext, so as to output a second ciphertext.

5. The method according to claim 1, wherein the method further comprises:
receiving first indication information indicating to destroy a homomorphic key, wherein the homomorphic key is a homomorphic encryption key, a homomorphic decryption key, or a homomorphic evaluation key; and
destroying the homomorphic key.

6. The method according to claim 1, wherein the method further comprises:
receiving second indication information indicating to update a homomorphic key, wherein the homomorphic key is a homomorphic encryption key, a homomorphic decryption key, or a homomorphic evaluation key; and
updating the homomorphic key.

7. The method according to claim 1, wherein the method further comprises:
storing a first ciphertext and key information corresponding to the first ciphertext, and/or a second ciphertext and key information corresponding to the second ciphertext, wherein the key information comprises one or more of a homomorphic encryption key, a homomorphic decryption key, a homomorphic evaluation key, a key derivation parameter, or a security context.

8. The method according to claim 1, wherein the homomorphic security capability of the network side, the homomorphic security capability of the terminal, the homomorphic encryption algorithm, first indication information, or second indication information is carried in signaling with encryption and integrity protection, and the signaling comprises radio resource control RRC signaling and/or non-access stratum NAS signaling with integrity protection.

9. A user-level homomorphic encryption management method, comprising:
sending a homomorphic security capability of a terminal; and
receiving an identifier of a homomorphic encryption algorithm determined by a network side based on the homomorphic security capability of the terminal and a homomorphic security capability of the network side.

10. The method according to claim 9, wherein the homomorphic security capability of the terminal is carried in a security mode complete message.

11. The method according to claim 9, wherein the method further comprises:
determining a homomorphic encryption key and/or a homomorphic decryption key based on the homomorphic encryption algorithm, wherein the homomorphic encryption key is used to encrypt a plaintext message into a first ciphertext, and the homomorphic decryption key is used to decrypt a second ciphertext into a plaintext message.

12. The method according to claim 9, wherein the method further comprises:
receiving a homomorphic evaluation key after a homomorphic encryption task is created, wherein the homomorphic evaluation key is used by one or more homomorphic evaluation parties in the homomorphic encryption task to perform homomorphic evaluation on a first ciphertext, so as to output a second ciphertext.

13. The method according to claim 12, wherein a life cycle of the homomorphic evaluation key is duration of the homomorphic encryption task.

14. The method according to claim 9, wherein the method further comprises:
receiving first indication information indicating to destroy a homomorphic key, wherein the homomorphic key is a homomorphic encryption key, a homomorphic decryption key, or a homomorphic evaluation key; and
destroying the homomorphic key.

15. The method according to claim 14, wherein a life cycle of the homomorphic encryption key or the homomorphic decryption key is within time between successful establishment and completion of release of a radio resource control RRC connection of a user, the user is a homomorphic encryption party or a homomorphic decryption party, and first indication information is carried in RRC release signaling.

16. The method according to claim 9, wherein the method further comprises:
receiving second indication information indicating to update a homomorphic key, wherein the homomorphic key is a homomorphic encryption key, a homomorphic decryption key, or a homomorphic evaluation key; and
updating the homomorphic key.

17. The method according to claim 9, wherein the method further comprises:
storing a first ciphertext and key information corresponding to the first ciphertext, and/or a second ciphertext and key information corresponding to the second ciphertext, wherein the key information comprises one or more of a homomorphic encryption key, a homomorphic decryption key, a homomorphic evaluation key, a key derivation parameter, or a security context.

18. The method according to claim 9, wherein the homomorphic security capability of the network side, the homomorphic security capability of the terminal, the homomorphic encryption algorithm, first indication information, or second indication information is carried in signaling with encryption and integrity protection, and the signaling comprises radio resource control RRC signaling and/or non-access stratum NAS signaling with integrity protection.

19. A user-level homomorphic encryption management method, comprising:
sending a homomorphic security capability of a network side; and
receiving an identifier of a homomorphic encryption algorithm determined by a terminal based on a homomorphic security capability of the terminal and the homomorphic security capability of the network side.

20. The method according to claim 19, wherein the homomorphic security capability of the network side is carried in a security mode command, and the homomorphic encryption algorithm is carried in a security mode complete message.
